(19) United States
(12) Patent Application Publication
(10) Pub. No.: US 2019/0208206 A1
(43) Pub. Date: Jul. 4, 2019

(54) IMAGE PROCESSING APPARATUS, IMAGE PROCESSING METHOD, AND PROGRAM

(71) Applicant: SONY CORPORATION, TOKYO (JP)

(72) Inventor: OHJI NAKAGAMI, TOKYO (JP)

(21) Appl. No.: 16/325,323

(22) PCT Filed: Jul. 21, 2017
(86) PCT No.: PCT/JP2017/026484

§ 371 Date: Feb. 13, 2019

(30) Foreign Application Priority Data
Sep. 12, 2016 (JP) 2016-177736

(51) Int. Cl. H04N 19/126; H04N 19/14; H04N 19/159; H04N 19/176

(52) U.S. Cl. CPC H04N 19/126; H04N 19/176; H04N 19/159; H04N 19/14

(57) ABSTRACT

[Object] To provide an image processing apparatus, an image processing method, and a program that can decrease the amount of transmission related to parameters further. [Solution] An image processing apparatus including: an inverse quantization control section that controls an inverse quantization on the basis of prediction block information or quantized coefficients.

### TECHNICAL FIELD

The present disclosure relates to an image processing apparatus, an image processing method, and a program.

### BACKGROUND ART

In technologies related to image encoding, various encoding parameters are transmitted from an encoder (image encoding apparatus) to a decoder (image decoding apparatus). For example, as described in Non-Patent Literature 1, among the transmitted encoding parameters, a quantization parameter QP and a differential quantization parameter dQP for adjusting the quantization parameter QP for each block may be included as parameters related to quantization.

### CITATION LIST

### Non-Patent Literature

Non-Patent Literature 1: K. Sato, M. Budagavi, M. Coban, H. Aoki, X. Li, “CE4: Summary report of Core Experiment on quantization”, JCTVC-F024, Joint Collaborative Team on Video Coding (JCT-VC) of ITU-T SG16 WP3 and ISO/IEC JTC1/SC29/WG11, 6th Meeting: Torino, IT, 14-22 Jul. 2011

### DISCLOSURE

### Technical Problem

However, if the differential quantization parameter dQP is transmitted for all blocks, the amount of transmission from the encoder to the decoder may increase.

Accordingly, a mechanism enabling the amount of transmission related to parameters to be decreased further is desired.

### Solution to Problem

According to the present disclosure, there is provided an image processing apparatus including: an inverse quantization control section that controls an inverse quantization on the basis of prediction block information or quantized coefficients.

In addition, according to the present disclosure, there is provided an image processing method including, by a processor: controlling an inverse quantization on the basis of prediction block information or quantized coefficients.

In addition, according to the present disclosure, there is provided a program causing a computer to execute a function of: controlling an inverse quantization on the basis of prediction block information or quantized coefficients.

### Advantageous Effects of Invention

According to the present disclosure as described above, it is possible to decrease the amount of transmission related to parameters further.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an example of quantization control according to the properties of the encoded block.

FIG. 2 is an explanatory diagram illustrating an example of quantization control according to the properties of the encoded block.

FIG. 3 is a block diagram illustrating one example of the configuration of an image encoding apparatus 10, which is one aspect of an image processing apparatus according to one embodiment of the present disclosure.

FIG. 4 is a block diagram illustrating one example of a detailed configuration of a quantization section 15 according to the embodiment.

FIG. 5 is a flowchart illustrating one example of a flow of a process during encoding according to the embodiment.

FIG. 6 is a flowchart illustrating a detailed flow of step S130 illustrated in FIG. 5.

FIG. 7 is a flowchart illustrating a detailed flow of step S140 illustrated in FIG. 5.

FIG. 8 is a block diagram illustrating one example of the configuration of an image decoding apparatus 60, which is one aspect of an image processing apparatus according to the embodiment.

FIG. 9 is a block diagram illustrating one example of a detailed configuration of an inverse quantization section 63 according to the embodiment.

FIG. 10 is a flowchart illustrating one example of a flow of a process during decoding according to the embodiment.

FIG. 11 is a flowchart illustrating a detailed flow of step S240 illustrated in FIG. 10.

FIG. 12 is a block diagram illustrating a principal configuration example of a computer.

FIG. 13 is a block diagram illustrating an example of a schematic configuration of a television apparatus.

FIG. 14 is a block diagram illustrating an example of a schematic configuration of a mobile telephone.

FIG. 15 is a block diagram illustrating an example of a schematic configuration of a recording/reproducing apparatus.

FIG. 16 is a block diagram illustrating an example of a schematic configuration of an imaging apparatus.

FIG. 17 is a block diagram illustrating one example of a schematic configuration of a video set.

FIG. 18 is a block diagram illustrating one example of a schematic configuration of a video processor.

FIG. 19 is a block diagram illustrating another example of a schematic configuration of a video processor.

FIG. 20 is a block diagram illustrating one example of a schematic configuration of a network system.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the description will proceed in the following order.

1. Overview

2. Configuration of image encoding apparatus

3. Flow of process when encoding

4. Configuration of image decoding apparatus

5. Flow of process when decoding

6. Exemplary hardware configuration

7. Application examples

8. Conclusion

### <1. Overview>

### [1-1. Background]

To describe one embodiment of the present disclosure, first, the background that led to the creation of one embodiment of the present disclosure will be described with reference to the drawings.

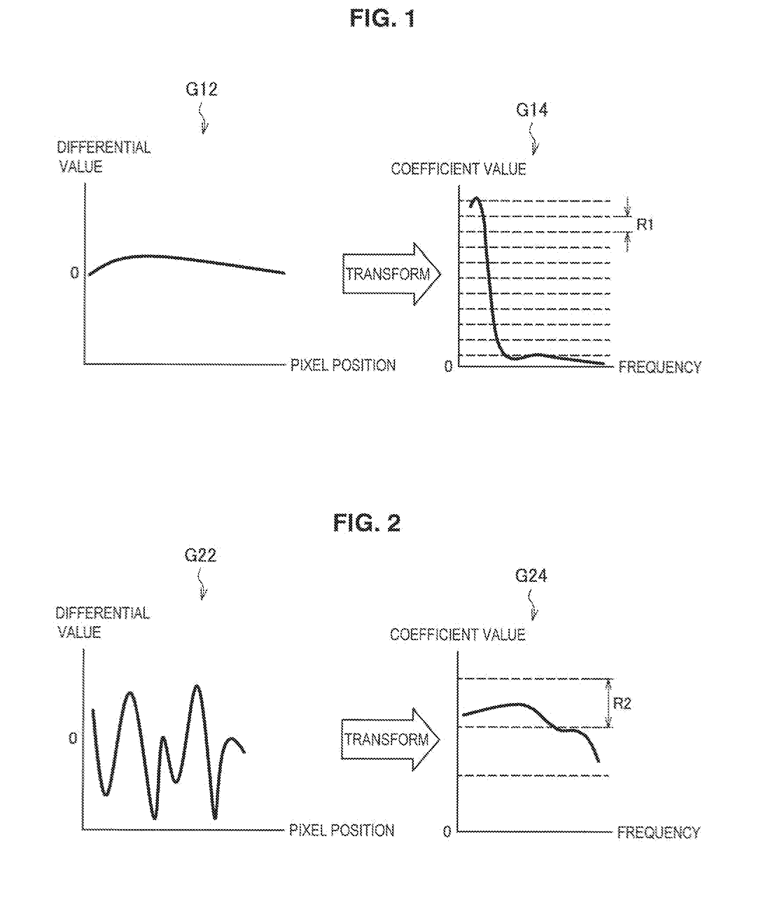

In image encoding, it is conceivable to control quantization according to the properties of the encoded block (for example, the coding unit (CU) in HEVC). FIGS. 1 and 2 are explanatory diagrams illustrating an example of quantization control according to the properties of the encoded block.

The graphs G12 and G22 in FIGS. 1 and 2 illustrate examples of a differential value in the encoded block. Also, the graphs G14 and G24 in FIGS. 1 and 2 illustrate examples of a transform coefficient value obtained by performing an orthogonal transform (such as the DCT, for example) that transforms a residual image according to each of the graphs G12 and G22 to the frequency domain.

For example, as illustrated in the graph G12 of FIG. 1, in the case in which the dynamic range of the differential value is narrow (the difference between the minimum value and the maximum value is small) and flat, as illustrated in the graph G14, for example, by decreasing the quantization step R1 in the low range of the transform coefficient, efficient encoding becomes possible.

On the other hand, as illustrated in the graph G22 of FIG. 2, in the case in which the dynamic range of the differential value is wide (the difference between the minimum value and the maximum value is large) and the variance value is also high, as illustrated in the graph G14, for example, by increasing the quantization step R2 in the low range of the transform coefficient, an increase in the number of bits may be suppressed.

As above, it is desirable to control parameters related to quantization according to the properties of the encoded block. The specification of the quantization step described above is one example, and quantization parameters may be controlled according to a variety of properties of the encoded block.

Parameters related to quantization specified during encoding as above may be transmitted from the encoder (image encoding apparatus) to the decoder (image decoding apparatus). For example, the quantization parameter QP corresponding to the quantization step and the differential quantization parameter dQP for adjusting the quantization parameter QP for each block may be transmitted from the encoder to the decoder. However, if the differential quantization parameter dQP is transmitted for all blocks, the amount of transmission from the encoder to the decoder may increase.

Accordingly, focusing on the above circumstances led to the creation of the present embodiment. According to the present embodiment, by controlling inverse quantization on the decoder side according to the properties of the encoded block, it is possible to decrease the amount of transmission from the encoder to the decoder. The image encoding apparatus and the image decoding apparatus according to the present embodiment detect a feature quantity from the encoded block, and execute quantization control and inverse quantization control corresponding to the feature quantity. Hereinafter, a feature quantity extraction process and a (inverse) quantization control process (a quantization control process and an inverse quantization control process) according to the present embodiment will be described in succession.

### [1-2. Feature Quantity Detection Process]

In the following, five examples will be described regarding the feature quantity detection process according to the present embodiment. Note that the feature quantities obtained by the first feature quantity detection process to the fifth feature quantity detection process described below will be called the feature quantities A1 to A5, respectively.

### (1) First Feature Quantity Detection Process

The first feature quantity detection process is a process that acquires a feature quantity A1 indicating the dynamic range in the predicted image. For example, the feature quantity A1 may be acquired by the first feature quantity detection process described below.

First, with respect to each prediction unit (PU) inside a CU, a feature quantity A1′ related to the PU is acquired as in Formula (1) below.

A1=Max{P(x, y)}−Min{P(x, y)} (1)

Note that in Formula (1), P(x, y) is a predicted pixel value at the position (x, y). Also, Max{P(x, y)} and Min{P(x, y)} express the maximum value and the minimum value, respectively, of predicted pixel values inside the PU.

For each PU included in the CU, the feature quantity A1′ indicating the dynamic range in the predicted image is acquired as in Formula (1), and the largest feature quantity A1′ in the CU is acquired as the feature quantity A1 of the CU.

(2) Second feature quantity detection process

The second feature quantity detection process is a process that acquires a feature quantity A2 indicating the variance in the predicted image. For example, the feature quantity A2 may be acquired by the second feature quantity detection process described below.

First, with respect to each PU inside a CU, a feature quantity A2′ related to the PU is acquired as in Formula (2) below.

A2′=Σ{(P(x, y)}−Average{P(x, y)})̂2} (2)

Note that in Formula (2), Average{P(x, y)} expresses the average of the predicted pixel values inside the PU. Also, Σ{ } expresses a process of summing the values inside { } for the position (x, y) inside the PU.

For each PU included in the CU, the feature quantity A2′ indicating the variance in the predicted image is acquired as in Formula (2), and the largest feature quantity A2′ in the CU is acquired as the feature quantity A2 of the CU.

### (3) Third Feature Quantity Detection Process

The third feature quantity detection process is a process that acquires a feature quantity A3 indicating the position of the highest-order coefficient in the quantized coefficients (the coefficients obtained by quantizing the transform coefficients). For example, the feature quantity A3 may be acquired by the third feature quantity detection process described below.

First, with respect to each transform unit (TU) inside a CU, a feature quantity A3 ′ related to the TU is acquired as in the pseudocode illustrated in Table 1 below.

TABLE 1
Example of pseudocode to compute feature quantity A3′

```
highest_coef_pos=0
for(i=0;i<TU_width;i++)
  for(j=0;j<TU_height;j++)
    if(TU[i][j]!=0&&(i+j)>highest_coef_pos)
      highest_coef_pos=(i+j)
A 3 ′ =highest_coef_pos/(TU_width+TU_height)
```

Note that in Table 1, TU_width and TU_height indicate the width and height of the TU, respectively. Also, in Table 1, TU[i][j] indicates the quantized coefficient value at the position (i, j).

For each TU included in the CU, the feature quantity A3′ indicating the position of the highest-order coefficient is acquired according to the process illustrated in Table 1, and the largest feature quantity A3′ in the CU is acquired as the feature quantity A3 of the CU.

### (4) Fourth Feature Quantity Detection Process

The fourth feature quantity detection process is a process that acquires a feature quantity A4 indicating a coefficient distribution density in the quantized coefficients. For example, the feature quantity A4 may be acquired by the fourth feature quantity detection process described below.

First, with respect to each transform unit (TU) inside a CU, a feature quantity A4′ related to the TU is acquired as in the pseudocode illustrated in Table 2 below.

TABLE 2
Example of pseudocode to compute feature quantity A4′

```
coef_count=0
for(i=0;i<TU_width;i++)
  for(j=0;j<TU_height;j++)
    if(TU[i][j]!=0)
        coef_count+=1
A 4 ′ =coef_count/(TU_width+TU_height)
```

For each TU included in the CU, the feature quantity A4′ indicating the coefficient distribution density is acquired according to the process illustrated in Table 2, and the largest feature quantity A4′ in the CU is acquired as the feature quantity A4 of the CU.

### (5) Fifth Feature Quantity Detection Process

The fifth feature quantity detection process is a process that acquires a feature quantity A5 indicating a prediction mode included in PU information (prediction block information) described later. For example, the feature quantity A5 may be acquired by the fifth feature quantity detection process described below.

First, with respect to each PU inside a CU, a feature quantity A5′ indicating whether or not a prediction mode related to the PU is an intra prediction mode is acquired. For example, in the case in which the prediction mode related to the PU is an intra prediction mode, A5′ may be 1, while in the case in which the prediction mode related to the PU is not an intra prediction mode, A5′ may be 2.

After the feature quantity A5′ indicating whether or not the prediction mode related to the PU is an intra prediction mode is acquired for each TU included in the CU, the average value of the feature quantities A5′ in the CU is acquired as the feature quantity A5′ indicating the prediction mode of the CU.

The above describes examples of feature quantity detection processes according to the present embodiment. Note that a feature quantity detection process according to the present embodiment is not limited to the above, and a feature quantity may also be acquired by a method other than the above. Next, a (inverse) quantization control process based on a feature quantity acquired as above will be described.

### [1-3. (Inverse) Quantization Control Process]

In the following, three examples will be described regarding the (inverse) quantization control process according to the present embodiment.

### (1) First (Inverse) Quantization Control Process

In the first (inverse) quantization control process, (inverse) quantization is controlled by specifying a quantization parameter used in the (inverse) quantization of a CU (coding block) on the basis of a feature quantity related to the CU. Note that in the following, a reference quantization parameter that serves as a reference is designated QP, while the quantization parameter of the CU used in the (inverse) quantization of the CU is designated QP′. Note that the reference quantization parameter QP may be a quantization parameter in units of pictures, or a quantization parameter in units of slices. For example, in the case in which a quantization parameter in units of slices is used as the reference quantization parameter QP, the quantization parameter in units of slices is decided from a quantization parameter in units of pictures and an adjustment value for the quantization parameter in units of slices. In such a case, the quantization parameter in units of pictures and the adjustment value for the quantization parameter in units of slices are transmitted from the encoder (image encoding apparatus) to the decoder (image decoding apparatus).

Also, the first (inverse) quantization control process is able to use the feature quantities A1 to A5 described above singly or in combination as the feature quantity. In the following, the feature quantity used in the first (inverse) quantization control process is designated the feature quantity Ax, but the feature quantity Ax may be any one of the feature quantities A1 to A5 described above, or a feature quantity specified by plurally combining the feature quantities Al to A5 described above.

TABLE 3
Example of pseudocode to compute quantization parameter QP′

```
if((f(Ax, TH_Ax, Sign)){
  QP′ =Clip3(0, 51, QP+D)
      }else{
  QP′ =QP
}
```

Note that in Table 3, TH_Ax is a threshold value with respect to the feature quantity Ax. Also, Sign is a positive or negative value. Also, D is a control width of the quantization parameter, such that as the control width D becomes smaller (as the absolute value of a negative value becomes larger), the image quality improvement effect is great, whereas in the case in which D is large, the bit reduction effect is high.

Also, in Table 3, Clip 3(min, max, X) means the value obtained by rounding the third argument X to the first argument min or greater and to the second argument max or less. Also, f(a, b, c) is a function for determining the result of a magnitude determination according to the sign of the third argument (in the example of Table 3, Sign) as in Formula (3) below.

f(a, b, c)=c>0? a<b:a>b (3)

TH_Ax, Sign, and D described above may be predefined values, for example, or may be values that are dynamically controlled in units of pictures by the encoder (image encoding apparatus) and transmitted in the bit stream. In the following, examples of the threshold values in the case in which the feature quantities A1 to A5 are used in the first (inverse) quantization control process will be described.

For example, a threshold value TH_A1 with respect to the feature quantity A1 is a threshold value satisfying Formula (4) below.

0<TH_A1<((1<<BitDepth)−1) (4)

Note that in Formula (4), BitDepth expresses the bit depth of the encoded image. For example, in the case of an 8-bit image, Formula (4) becomes like Formula (5) below.

0<TH_A1<255 (5)

For example, in the case of detecting a flat part or a gradation region, it is desirable to set TH_A1 to a small value (a value approximately from 1/20 to 1/10 compared to the bit depth), and set Sign>0. For example, in the case of expecting an effect of improved image quality with respect to a flat part, each parameter may be set such that TH_A1=16 and Sign>0 and D=−6 or the like.

Also, in the case in which a threshold value TH_A2 with respect to the feature quantity A2 is small (for example, the case of being smaller than the value of approximately squaring 1/20 to 1/10 of the bit depth), and Sign>0, the detection of a flat part or gradation region becomes possible. For example, in the case of expecting an effect of improved image quality with respect to a flat part, each parameter may be set such that TH_A2=64 and Sign>0 and D=−6 or the like.

On the other hand, in the case in which the threshold value TH_A2 with respect to the feature quantity A2 is large (for example, the case of being larger than the value of approximately squaring ¼ to ½ of the bit depth), and Sign<0, the detection of a textured part becomes possible. For example, in the case of expecting an effect of moderating the number of bits for a textured part, each parameter may be set such that TH_A2=4096 and Sign<0 and D=+6 or the like.

Also, in the case in which a threshold value TH_A3 with respect to the feature quantity A3 is small (for example, approximately 0.25 or less), and Sign>0, the detection of a flat part or gradation region becomes possible. On the other hand, in the case in which the threshold value TH_A3 with respect to the feature quantity A3 is large (for example, approximately 0.75 or greater), and Sign<0, the detection of a textured part becomes possible.

Also, in the case in which a threshold value TH_A4 with respect to the feature quantity A4 is small (for example, approximately 0.25 or less), and Sign>0, the detection of a flat part or gradation region becomes possible. On the other hand, in the case in which the threshold value TH_A4 with respect to the feature quantity A4 is large (for example, approximately 0.75 or greater), and Sign<0, the detection of a textured part becomes possible.

In addition, for example, by setting a threshold value TH_A5 with respect to the feature quantity A5 to an intermediate value of the values (1 or 2) indicating whether or not the prediction mode is an intra prediction mode, and by setting Sign>0, the detection of an occlusion region becomes possible. For example, in the case of expecting an effect of improved image quality with respect to an occlusion region, each parameter may be set such that TH_A2=1.5 and Sign>0 and D=−6 or the like. On the other hand, in the case of expecting an effect of moderating the number of bits for an occlusion region, each parameter may be set such that TH_A2=1.5 and Sign>0 and D=+6 or the like.

### (2) Second (Inverse) Quantization Control Process

In the second (inverse) quantization control process, (inverse) quantization is controlled by specifying a quantization parameter used in the (inverse) quantization of the direct-current component (DC component) in a CU (coding block) on the basis of a feature quantity related to the CU.

Also, the second (inverse) quantization control process is able to use, for example, the feature quantities A1 and A2 described above singly or in combination as the feature quantity. Note that in the following, the reference quantization parameter is designated QP, while the quantization parameter used in the (inverse) quantization of the DC component (direct-current component) in the CU is designated QP′.

For example, the quantization parameter QP′ used in the (inverse) quantization of the DC component in the CU may be acquired similarly to the first (inverse) quantization control process described with reference to Table 3. Additionally, in the second (inverse) quantization control process, only the DC component of the CU may be quantized using the quantization parameter QP′, while the non-DC component of the CU may be quantized using the reference quantization parameter QP, for example.

Also, in the second (inverse) quantization control process, the threshold values TH_A1 and TH_A2 with respect to each of the feature quantities A1 and A2, Sign, and the control width D may be set similarly to the first (inverse) quantization control process, and effects similar to the first (inverse) quantization control process may be obtained.

### (3) Third (Inverse) Quantization Control Process

In the third (inverse) quantization control process, (inverse) quantization is controlled by specifying a quantization parameter used in the (inverse) quantization of a predetermined frequency component in a CU (coding block) on the basis of a feature quantity related to the CU.

Also, the third (inverse) quantization control process is able to use, for example, the feature quantities A3 and A4 described above singly or in combination as the feature quantity. Note that in the following, the reference quantization parameter is designated QP, while the quantization parameter used in the (inverse) quantization of the predetermined frequency component in the CU is designated QP′.

For example, the quantization parameter QP′ used in the (inverse) quantization of the predetermined frequency component in the CU may be acquired similarly to the first (inverse) quantization control process described with reference to Table 3. Additionally, in the third (inverse) quantization control process, only the predetermined frequency component of the CU may be quantized using the quantization parameter QP′, while components other than the predetermined frequency component of the CU may be quantized using the reference quantization parameter QP, for example.

The predetermined frequency component may be a signal in the horizontal direction, a signal in the vertical direction, or the like, for example. For example, by setting only the quantization parameter related to a signal in the horizontal direction or the vertical direction to a small value, it is possible to protect periodic patterns in the horizontal direction or the vertical direction. In such a case, for example, in such a case, the threshold value TH_A3 with respect to the feature quantity A3 and the threshold value TH_A4 with respect to the feature quantity A4 may be set to large values (for example, approximately 0.75 or greater), and Sign<0, D=−6 and the like may be set.

The above describes the (inverse) quantization control process according to the present embodiment. Note that in the above, the process of computing the quantization parameter QP′ of the CU from each feature quantity is described without distinguishing between quantization control and inverse quantization control, but the process of computing the quantization parameter QP from the feature quantity A3 and the feature quantity A4 may be different between the quantization control in the encoding process and the inverse quantization control in the decoding process. This is because although the feature quantity A3 and the feature quantity A4 are values specified on the basis of the quantized coefficients as described above, the quantized coefficients in the encoding process are coefficients obtained after quantization using the quantization parameter QP′.

For this reason, in the case of computing a quantization parameter on the basis of the feature quantity A3 and the feature quantity A4, the inverse quantization control process in the decoding process is as described above, but for the quantization control in the encoding process, a process that is partially different from the process described above is performed. In quantization control, the process of specifying a quantization parameter on the basis of the feature quantity A3 and the feature quantity A4 will be described later.

The above describes an overview of the present embodiment. Next, a configuration and a process flow according to the present embodiment will be described.

### <2. Configuration of Image Encoding Apparatus>

### [2-1. Overall Configuration]

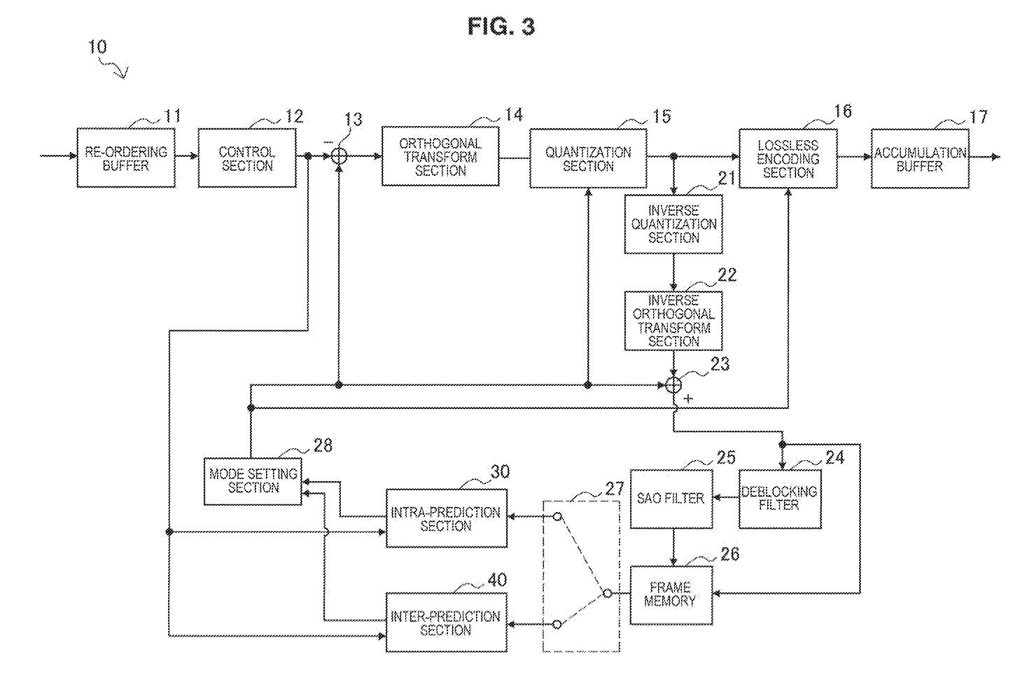

FIG. 3 is a block diagram illustrating one example of the configuration of an image encoding apparatus 10, which is one aspect of an image processing apparatus according to the present embodiment. Referring to FIG. 3, the image encoding apparatus 10 is provided with a re-ordering buffer 11, a control section 12, a subtraction section 13, an orthogonal transform section 14, a quantization section 15, a lossless encoding section 16, an accumulation buffer 17, an inverse quantization section 21, an inverse orthogonal transform section 22, an addition section 23, a deblocking filter 24, an SAO filter 25, frame memory 26, a switch 27, a mode setting section 28, an intra-prediction section 30, and an inter-prediction section 40.

The re-ordering buffer 11 re-orders the image data of a series of images included in video to be encoded, in accordance with a Group of Pictures (GOP) structure according to the encoding process. The re-ordering buffer 11 outputs the re-ordered image data to the control section 12, the subtraction section 13, the intra-prediction section 30, and the inter-prediction section 40.

The control section 12 decides control parameters to be supplied to each section on the basis of rate-distortion optimization (RDO), for example. The decided control parameters are supplied to each block.

For example, the control parameters decided by the control section 12 may include block information indicating how the coding tree unit (CTU), coding unit (CU), transform unit (TU), prediction unit (PU), and the like of HEVC should be set.

Also, the control parameters decided by the control section 12 may include a quantization parameter in units of pictures and an adjustment value for the quantization parameter in units of slices. Furthermore, the control parameters decided by the control section 12 may include information indicating which feature quantity to use from among the feature quantities Al to A5 described above, and information indicating which control process to perform from among the three (inverse) quantization control processes described above. The control section 12 may also decide a combination of a feature quantity and a control process according to which effect is expected from among the effects obtained by the combinations of feature quantities and control processes described above, for example.

Note that the control parameters decided by the control section 12 may be any parameters, and may include a variety of information not limited to the information described above.

The subtraction section 13 calculates prediction error data, which is the difference between the image data input from the re-ordering buffer 11 and the predicted image data, and outputs the calculated prediction error data (residual signal) to the orthogonal transform section 14.

The orthogonal transform section 14 executes an orthogonal transform process for each of one or more transform blocks (TUs) set inside each region. The orthogonal transform at this point may be the discrete cosine transform, the discrete sine transform, or the like, for example. More specifically, the orthogonal transform section 14 transforms the prediction error data input from the subtraction section 13 from an image signal in the spatial domain to transform coefficients in the frequency domain for each transform block. Subsequently, the orthogonal transform section 14 outputs the transform coefficients to the quantization section 15.

The quantization section 15 is supplied with transform coefficients input from the orthogonal transform section 14, as well as predicted image data and PU information from the mode setting section 28 described later. The quantization section 15 uses the quantization parameter specified by the quantization control described above to quantize the transform coefficients. The quantization section 15 outputs the quantized coefficients obtained by quantizing the transform coefficients and quantization control information related to the control of quantization to the lossless encoding section 16 and the inverse quantization section 21. Note that a more detailed configuration of the quantization section 15 will be described further later.

The lossless encoding section 16 generates an encoded stream by encoding quantized coefficients input from the quantization section 15. Also, the lossless encoding section 16 encodes various encoding parameters to be referenced by the decoder, and inserts the encoded encoding parameters into the encoded stream. The encoding parameters encoded by the lossless encoding section 16 may include the control parameters decided by the control section 12 described above, PU information input from the mode setting section 28, information related to intra-prediction, and information related to inter-prediction. The lossless encoding section 16 outputs the generated encoded stream to the accumulation buffer 17.

The accumulation buffer 17 uses a storage medium such as semiconductor memory to temporarily buffer the encoded stream input from the lossless encoding section 16. Subsequently, the accumulation buffer 17 outputs the buffered encoded stream to a transmission section not illustrated (such as a communication interface or a connection interface that connects with peripheral equipment, for example), at a rate according to the bandwidth of the transmission channel.

The inverse quantization section 21, the inverse orthogonal transform section 22, and the addition section 23 form a local decoder. The local decoder has a role of reconstructing an original image from encoded data.

The inverse quantization section 21 inversely quantizes the quantized coefficients with the same quantization parameter as that used by the quantization section 15, and restores the transform coefficient data. Subsequently, the inverse quantization section 21 outputs the restored transform coefficient data to the inverse orthogonal transform section 22.

The addition section 23 adds the restored prediction error data input from the inverse orthogonal transform section 22 to the predicted image data input from the intra-prediction section 30 or the inter-prediction section 40 to thereby generate decoded image data (reconstructed image). Then, the addition section 23 outputs the generated decoded image data to the deblocking filter 24 and the frame memory 26.

The deblocking filter 24 and the SAO filter 25 are both in-loop filters for improving image quality of reconstructed images. The deblocking filter 24 removes block distortions by filtering the decoded image data input from the addition section 23, and outputs the filtered decoded image data to the SAO filter 25. The SAO filter 25 removes noises by applying an edge offset process or a band offset process to the decoded image data input from the deblocking filter 24, and outputs the processed decoded image data to the frame memory 26.

The frame memory 26 stores the un-filtered decoded image data input from the addition section 23 and the decoded image data to which in-loop filtering has been applied input from the SAO filter 25 in a storage medium.

The switch 27 reads the un-filtered decoded image data to be used for the intra-prediction out from the frame memory 26 and supplies the read decoded image data as reference image data to the intra-prediction section 30. Further, the switch 27 reads the filtered decoded image data to be used for the inter-prediction out from the frame memory 26 and supplies the read decoded image data as reference image data to the inter-prediction section 40.

The mode setting section 28 sets a prediction mode (predictive encoding mode) for each block on the basis of a comparison of costs input from the intra-prediction section 30 and the inter-prediction section 40. For a block in which an intra-prediction mode is set, the mode setting section 28 outputs the predicted image data generated by the intra-prediction section 30 to the subtraction section 13. Also, for a block in which an inter-prediction mode is set, the mode setting section 28 outputs the predicted image data generated by the inter-prediction section 40 to the subtraction section 13.

Additionally, the mode setting section 28 outputs the predicted image data and PU information (prediction block information) related to the generation of the predicted image to the quantization section 15 and the lossless encoding section 16. The PU information includes information related to the setting of the PU (prediction block), information indicating the prediction mode, and information related to intra-prediction/inter-prediction, for example.

The intra-prediction section 30 performs an intra-prediction process for each of PUs in HEVC on the basis of original image data and decoded image data. For example, the intra-prediction section 30 evaluates a cost based on a prediction error and an amount of code to be generated for each of prediction mode candidates within a search range. Then, the intra-prediction section 30 selects a prediction mode which minimizes the cost as an optimum prediction mode. In addition, the intra-prediction section 30 generates a predicted image data in accordance with the selected optimum prediction mode. Then, the intra-prediction section 30 outputs information regarding intra-prediction including prediction mode information indicating the optimum prediction mode, a corresponding cost, and the predicted image data to the mode setting section 28.

The inter-prediction section 40 executes an inter-prediction process (motion compensation) for each PU of HEVC, on the basis of original image data and decoded image data. For example, the inter-prediction section 40 evaluates a cost based on a prediction error and a generate code rate for each prediction mode candidate included in a search range specified by HEVC. Next, the inter-prediction section 40 selects the prediction mode yielding the minimum cost, or in other words the prediction mode yielding the highest compression ratio, as an optimal prediction mode. In addition, the inter-prediction section 40 generates predicted image data in accordance with the selected optimal prediction mode. Subsequently, the inter-prediction section 40 outputs information related to inter-prediction, the corresponding cost, and the predicted image data to the mode setting section 28.

### [2-2. Quantization Section]

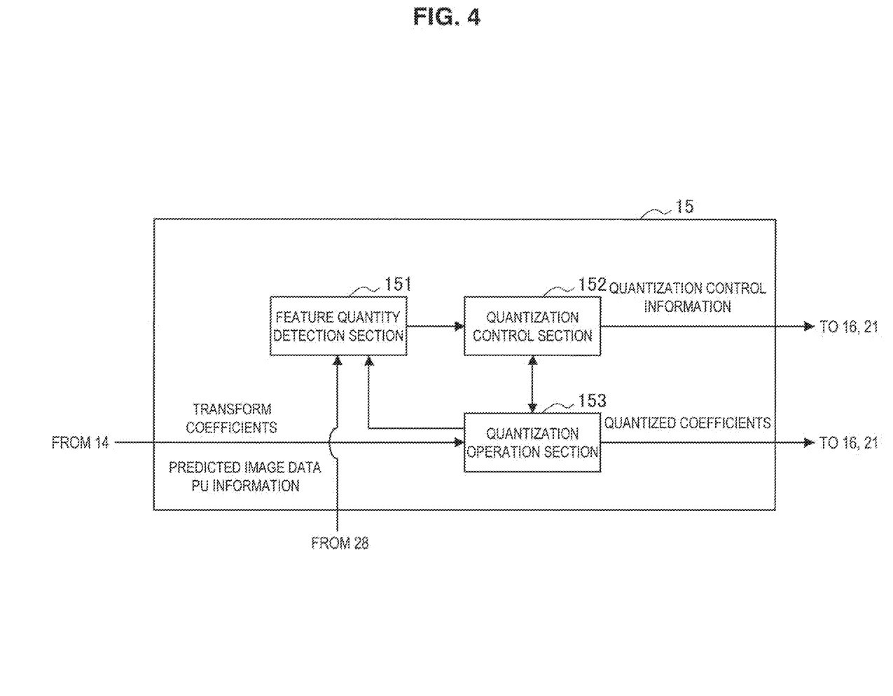

FIG. 4 is a block diagram illustrating one example of a detailed configuration of the quantization section 15 illustrated in FIG. 3. Referring to FIG. 4, the quantization section 15 includes a feature quantity detection section 151, a quantization control section 152, and a quantization operation section 153.

The feature quantity detection section 151 performs the first feature quantity detection process to the fifth feature quantity detection process on the basis of the predicted image included in the predicted image data and the PU information provided by the mode setting section 28, and acquires the feature quantities A1 to A5 described above. The feature quantity detection section 151 may also acquire feature quantities by determining which feature quantities to acquire on the basis of the control parameters decided by the control section 12, for example.

The quantization control section 152 controls quantization on the basis of the feature quantities acquired by the feature quantity detection section 151. The quantization control section 152 may also specify a quantization parameter and control the quantization by the quantization operation section 153 by performing one of the quantization control processes from among the first quantization control process, the second quantization control process, and the third quantization control process described above. Additionally, the quantization control section 152 outputs quantization control information including the specified quantization parameter to the quantization operation section 153, the lossless encoding section 16, and the inverse quantization section 21.

Note that, as described above, in the case of computing a quantization parameter on the basis of the feature quantity A3 and the feature quantity A4, the quantization control section 152 performs a process that is partially different from the process described above. Hereinafter, the process in the case in which the quantization control section 152 specifies a quantization parameter on the basis of the feature quantity A3 and the feature quantity A4 will be described. Note that in the following, an example of specifying the quantization parameter to be used in the quantization of each CU according to the first quantization process on the basis of the feature quantity A3 will be described as an example.

In such an example, in the image decoding process, the quantization control section 152 searches for a quantization parameter from which the quantization parameter QP′ to be used in the quantization of the CU is recoverable from the reference quantization parameter QP and the quantized coefficients.

First, the quantization control section 152 moves a provisional quantization parameter q in a predetermined search range on the basis of the reference quantization parameter QP, and outputs the provisional quantization parameter q to the quantization operation section 153. At this point, the predetermined search range may be QP−αa<q<QP+α (where a is a given value greater than 0), for example.

The quantized coefficients obtained by the quantization operation section 153 quantizing the transform coefficients using the transform coefficients is input into the feature quantity detection section 151, and through the third feature quantity detection process by the feature quantity detection section 151, the feature quantity A3 corresponding to the provisional quantization parameter q is obtained.

The quantization control section 152 uses the feature quantity A3 corresponding to the provisional quantization parameter q to compute the quantization parameter QP′ corresponding to the provisional quantization parameter q according to the method described with reference to Table 3. In the case in which the values of the quantization parameter QP′ corresponding to the provisional quantization parameter q and the provisional quantization parameter q match, the search for the quantization parameter is discontinued. Also, the quantization control section 152 causes the quantization operation section 153 to output the quantized coefficients quantized using the provisional quantization parameter q (=the quantization parameter QP′ corresponding to the provisional quantization parameter q) to the lossless encoding section 16 and the inverse quantization section 21.

According to such a quantization control process, in the image decoding apparatus described later, it is possible to specify the quantization parameter QP′ used for quantization from the reference quantization parameter QP and the quantized coefficients.

Note that although the above describes an example of specifying the quantization parameter on the basis of the feature quantity A3, the case in which the feature quantity A4 is used is also similar.

Also, although the above describes an example of specifying the quantization parameter used for the quantization of each CU according to the first quantization process, the case of specifying the quantization parameter used for the quantization of a predetermined frequency component according to the third quantization control process is also similar. However, in the case in which the third quantization control process is performed, the provisional quantization parameter q is used only for the quantization of the predetermined frequency component, while the reference quantization parameter QP is used for the quantization of other components.

The quantization operation section 153 uses the quantization parameter specified by the quantization control section 152 to quantize the transform coefficients input from the orthogonal transform section 14, and obtains quantized coefficients. Subsequently, the quantization operation section 153 outputs the quantized coefficients to the lossless encoding section 16 and the inverse quantization section 21. Note that the quantization parameter set by the quantization control section 152 may also be used during the inverse quantization in the inverse quantization section 21.

### <3. Flow of Process When Encoding>

### [3-1. Overall Process Flow]

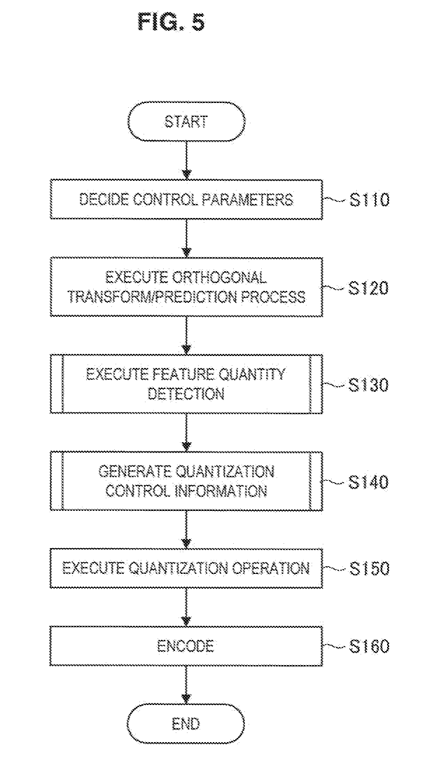

FIG. 5 is a flowchart illustrating one example of a flow of a process during encoding according to the present embodiment.

Referring to FIG. 5, first, the control section 12 decides controls parameters (S110). Next, an orthogonal transform is performed by the orthogonal transform section 14 on prediction error data input from the subtraction section 13, while on the other hand, a prediction process is performed by the intra-prediction section 30 and the inter-prediction section 40 (S120). The orthogonal transform and the prediction process in step S120 may be processed in parallel.

Next, the feature quantity detection section 151 of the quantization section 15 detects (acquires) feature quantities on the basis of a predicted image and PU information obtained in step S120 (S130). Note that details about the process in step S130 will be described later. Next, the quantization control section 152 of the quantization section 15 specifies a quantization parameter to use for quantization on the basis of the feature quantities, and generates quantization control information including the quantization parameter (S140). Note that details about the process in step S140 will be described later.

Next, the quantization operation section 153 of the quantization section 15 uses the quantization parameter specified by the quantization control section 152 to quantize the transform coefficients obtained in step S120 and obtain quantized coefficients (S150).

Next, the lossless encoding section 16 encodes the quantized coefficients obtained by the process in step S150 (S160). Also, at this time, the lossless encoding section 16 encodes encoding parameters including the control parameters, PU information, and the like.

### [3-2. Flow of Feature Quantity Detection Process]

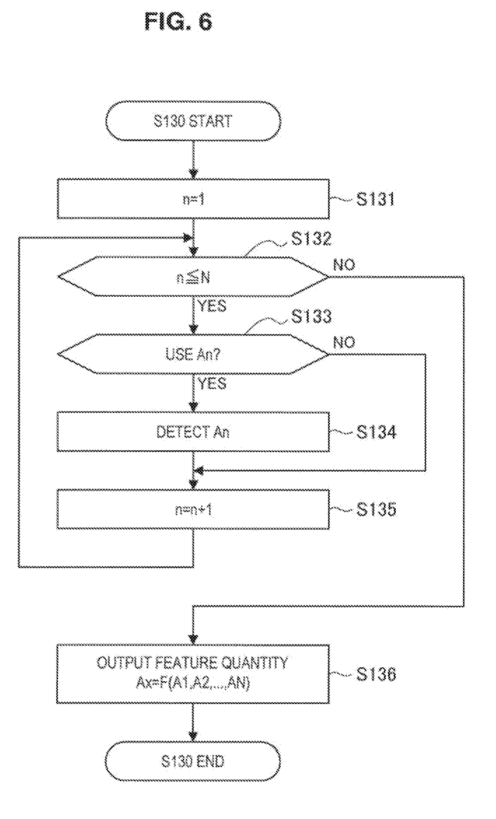

FIG. 6 is a flowchart illustrating a detailed flow of step S130 illustrated in FIG. 5.

Referring to FIG. 6, an integer variable n is set to n=1 (S131). Next, the sizes of the variable n and the number of feature quantities N are compared (S132).

In the case in which the variable n is equal to or less than the number of feature quantities N (YES in S132), and in the case of using the feature quantity An in the generation of quantization control information described later (YES in S133), the feature quantity detection section 151 detects (acquires) the feature quantity An (S134). Next, n is incremented (S135).

On the other hand, in the case of not using the feature quantity An in the generation of quantization control information (NO in S133), the feature quantity An is not detected, and n is incremented (S135).

The process from step S132 to S135 described above is repeated until the variable n becomes greater than the number of feature quantities N, and in the case in which the variable n has become greater than the number of feature quantities N (NO in S132), the feature quantity detection section 151 outputs the feature quantity Ax including the detected feature quantities to the quantization control section 152 (S136).

### [3-3. Flow of Quantization Control Information Generation Process]

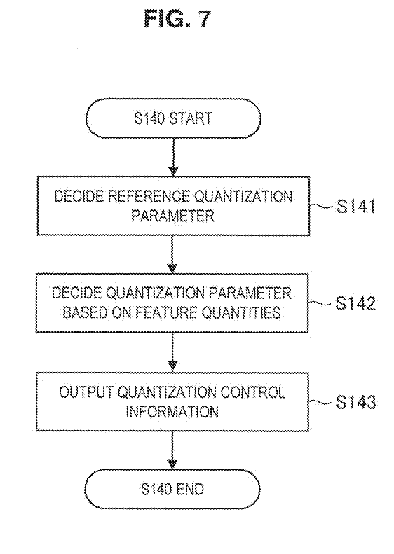

FIG. 7 is a flowchart illustrating a detailed flow of step S140 illustrated in FIG. 5.

Referring to FIG. 7, first, the reference quantization parameter QP is decided (S141). For example, the reference quantization parameter may be decided as a quantization parameter in units of slices by using a quantization parameter in units of pictures and an adjustment value for the quantization parameter in units of slices decided by the control section 12.

Next, the quantization control section 152 decides (specifies) the quantization parameter on the basis of the feature quantities detected in step S130 (S142). At this point, the quantization parameter may be specified according to a quantization control process decided by the control section 12 from among the first quantization control process to the third quantization control process described above.

Next, the quantization control section 152 outputs quantization control information including the quantization parameter specified in S142 to the quantization operation section 153, the lossless encoding section 16, and the inverse quantization section 21 (S143).

By executing each process as above, the image encoding apparatus 10 is able to decrease the amount of parameter-related transmission further, without having to transmit a differential quantization parameter for adjusting the quantization parameter for each block.

Note that the units of processing for each process described above may be any units, and do not have to be the same as each other. Consequently, the process in each step can also be executed in parallel with the process of another step or the like, or alternatively, the processing order in which to execute the processes may be rearranged.

### <4. Configuration of Image Decoding Apparatus>

### [4-1. Overall Configuration]

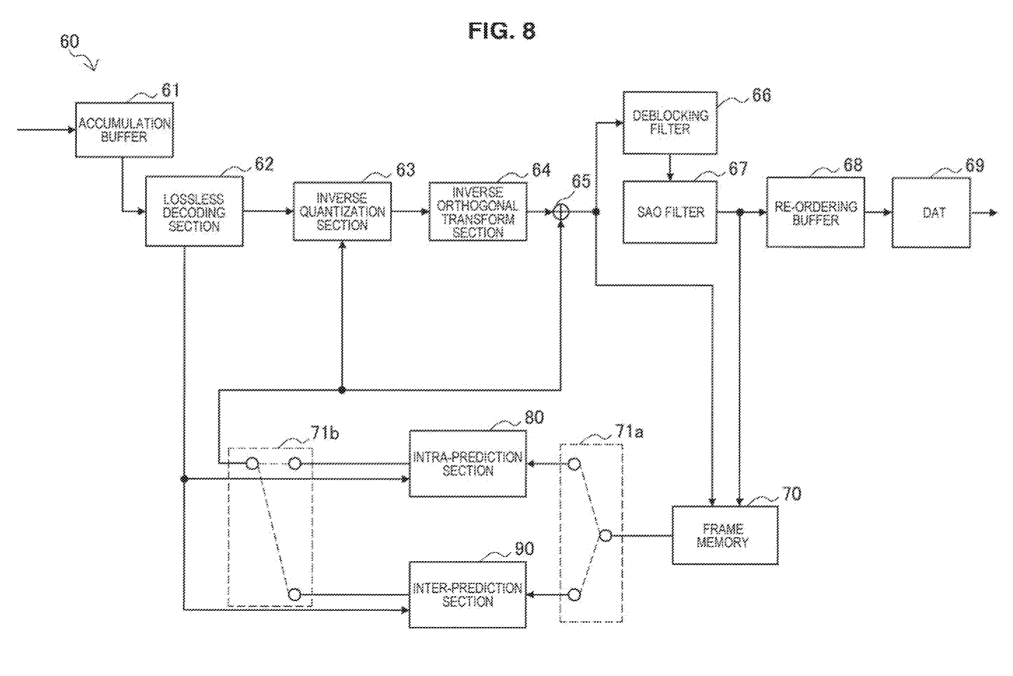

Next, the decoding of encoded data encoded as above will be described. FIG. 8 is a block diagram illustrating one example of the configuration of an image decoding apparatus 60, which is one aspect of an image processing apparatus according to the present embodiment. Referring to FIG. 8, an accumulation buffer 61, a lossless decoding section 62, an inverse quantization section 63, and an inverse orthogonal transform section 64, an addition section 65, a deblocking filter 66, an SAO filter 67, a re-ordering buffer 68, a digital to analog (D/A) conversion section 69, frame memory 70, selectors 71a and 71b, an intra-prediction section 80, and an inter-prediction section 90 are provided.

The accumulation buffer 61 uses a storage medium to temporarily buffer an encoded stream received from the image encoding apparatus 10 via a transmission section not illustrated (such as a communication interface or a connection interface that connects with peripheral equipment, for example).

The lossless decoding section 62 decodes quantized coefficients from the encoded stream input from the accumulation buffer 61, in accordance with the encoding scheme used during encoding. Also, the lossless decoding section 62 decodes various encoding parameters inserted into the header area of the encoded stream. The parameters decoded by the lossless decoding section 62 may include the encoding parameters decided by the control section 12, PU information, and the like described above, for example.

The lossless decoding section 62 outputs the quantized coefficients and the PU information to the inverse quantization section 63. Also, the lossless decoding section 62 outputs information related to intra-prediction included in the PU information to the intra-prediction section 80. Also, the lossless decoding section 62 outputs information related to inter-prediction included in the PU information to the inter-prediction section 90.

The inverse quantization section 63 is supplied with quantized coefficients and PU information input from the lossless decoding section 62, and also with predicted image data input from the selector 71b. The inverse quantization section 63 inversely quantizes the quantized coefficients on the basis of the PU information or a predicted image included in the predicted image data, and restores transform coefficient data. The inverse quantization section 63 outputs the restored transform coefficient data to the inverse orthogonal transform section 64. Note that a more detailed configuration of the inverse quantization section 63 will be further described later.

The inverse orthogonal transform section 64 generates prediction error data by performing an inverse orthogonal transform on the transform coefficient data input from the inverse quantization section 63, in accordance with the orthogonal transform scheme used during encoding. The inverse orthogonal transform section 64 outputs the generated prediction error data to the addition section 65.

The addition section 65 generates decoded image data by adding the prediction error data input from the inverse orthogonal transform section 64 to predicted image data input from the selector 7 lb. Then, the addition section 65 outputs the generated decoded image data to the deblocking filter 66 and the frame memory 70.

The deblocking filter 66 removes a block distortion by filtering the decoded image data input from the addition section 65 and outputs the filtered decoded image data to the SAO filter 67.

The SAO filter 67 removes noises by applying an edge offset process or a band offset process to the decoded image data input from the deblocking filter 66 and outputs the processed decoded image data to the re-ordering buffer 68 and the frame memory 70.

The re-ordering buffer 68 re-orders images input from the SAO filter 67, thereby generating a sequence of time-series image data. Then, the re-ordering buffer 68 outputs the generated image data to the D/A conversion section 69.

The D/A conversion section 69 converts image data in a digital format input from the re-ordering buffer 68 into an image signal in an analog format. Subsequently, for example, the D/A conversion section 69 outputs the analog image signal to a display (not illustrated) connected to the image decoding apparatus 60, and thereby causes decoded video to be displayed.

The frame memory 70 stores the unfiltered decoded image data input from the addition section 65 and the filtered decoded image data input from the SAO filter 67 in a storage medium.

The selector 71a switches an output destination of the image data from the frame memory 70 between the intra-prediction section 80 and the inter-prediction section 90 for each block in the image in accordance with prediction mode information included in PU information acquired by the lossless decoding section 62. In the case where an intra-prediction mode has been designated, for example, the selector 71a outputs the decoded image data that has not been filtered supplied from the frame memory 70 to the intra-prediction section 80 as reference image data. In addition, in the case where an inter-prediction mode has been designated, the selector 71a outputs the filtered decoded image data to the inter-prediction section 90 as reference image data.

The selector 71b switches an output source of the predicted image data to be supplied to the addition section 65 between the intra-prediction section 80 and the inter-prediction section 90 in accordance with prediction mode information included in PU information acquired by the lossless decoding section 62. In the case where the intra-prediction mode has been designated, for example, the selector 71b supplies the predicted image data output from the intra-prediction section 80 to the inverse quantization section 63 and the addition section 65. In addition, in the case where the inter-prediction mode has been designated, the selector 71b supplies the predicted image data output from the inter-prediction section 90 to the inverse quantization section 63 and the addition section 65.

The intra-prediction section 80 performs an intra-prediction process on the basis of information regarding intra-prediction included in PU information input from the lossless decoding section 62 and the reference image data from the frame memory 70, thereby generating the predicted image data. Then, the intra-prediction section 80 outputs the generated predicted image data to the selector 71b.

The inter-prediction section 90 performs an inter-prediction process on the basis of information regarding inter-prediction included in PU information input from the lossless decoding section 62 and the reference image data from the frame memory 70, thereby generating the predicted image data. Then, the inter-prediction section 90 outputs the generated predicted image data to the selector 71b.

### [4-2. Inverse Quantization Section]

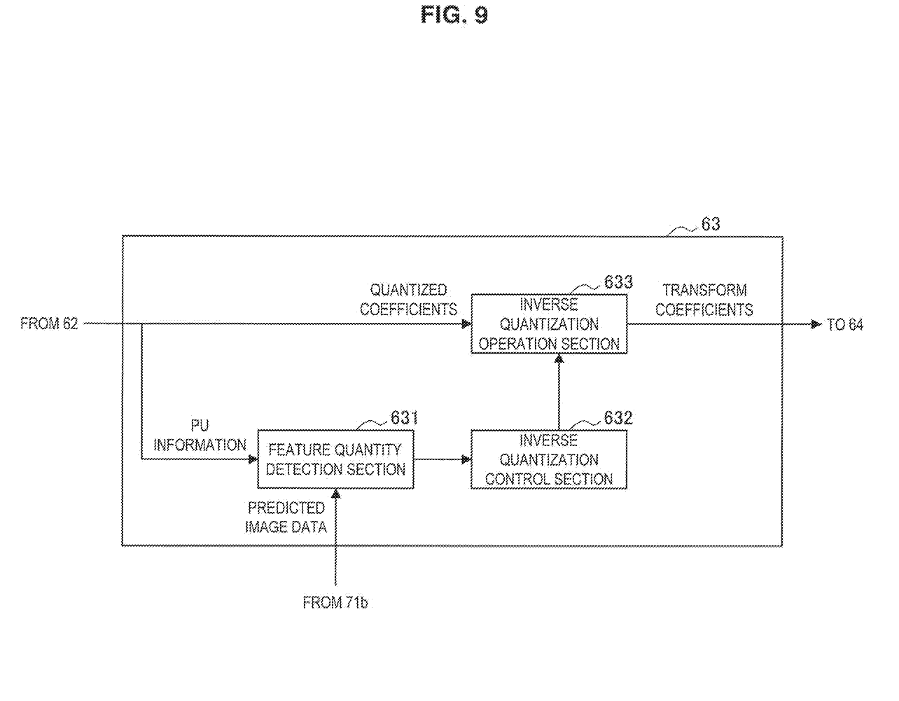

FIG. 9 is a block diagram illustrating one example of a detailed configuration of the inverse quantization section 63 illustrated in FIG. 8. Referring to FIG. 9, the inverse quantization section 63 includes a feature quantity detection section 631, an inverse quantization control section 632, and an inverse quantization operation section 633.

The feature quantity detection section 631 acquires the feature quantities A1 to A5 described above by performing the first feature quantity detection process to the fifth feature quantity detection process on the basis of the predicted image included in the predicted image data generated by the intra-prediction section 80 or the inter-prediction section 90 on the basis of the PU information and provided by the selector 71b, and the PU information provided by the lossless decoding section 62. The feature quantity detection section 631 may also acquire feature quantities by determining which feature quantities to acquire on the basis of the encoding parameters acquired by the lossless decoding section 62, for example.

The inverse quantization control section 632 controls inverse quantization on the basis of the feature quantities acquired by the feature quantity detection section 631. The inverse quantization control section 632 may also specify a quantization parameter and control the inverse quantization by the inverse quantization operation section 633 by performing one of the inverse quantization control processes from among the first inverse quantization control process, the second inverse quantization control process, and the third inverse quantization control process described above. Also, the inverse quantization control section 632 outputs inverse quantization control information including the specified quantization parameter to the inverse quantization operation section 633.

The inverse quantization operation section 633 uses the quantization parameter specified by the inverse quantization control section 632 to inversely quantize the quantized coefficients input from the lossless decoding section 62, and obtain transform coefficients. Subsequently, the inverse quantization operation section 633 outputs the transform coefficients to the inverse orthogonal transform section 64.

<5. Flow of Process when Decoding>

### [5-1. Overall Process Flow]

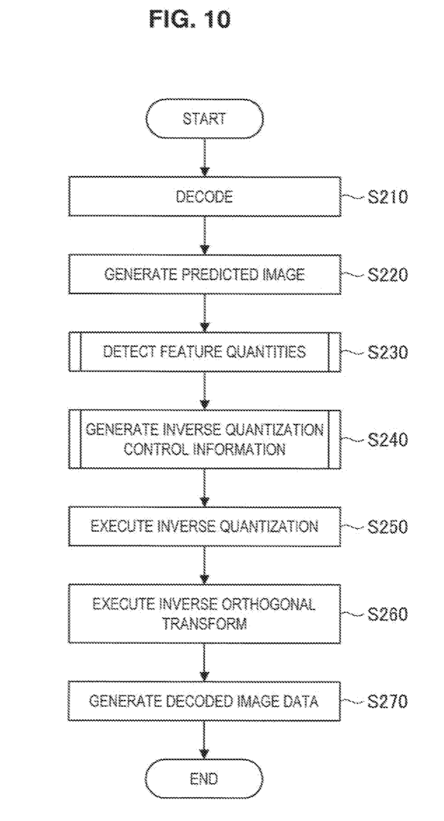

FIG. 10 is a flowchart illustrating an example of a flow of a process when decoding according to the present embodiment.

Referring to FIG. 10, first, the lossless decoding section 62 performs the decoding process to acquire (decode) quantized coefficients and encoding parameters (S210). The encoding parameters acquired in step S210 may include block information, a quantization parameter in units of pictures, an adjustment value for the quantization parameter in units of slices, PU information, and the like. In addition, the encoding parameters acquired in step S210 may also include information indicating which feature quantities and which quantization control process were used during encoding.

Next, a predicted image is generated by the intra-prediction section 80 or the inter-prediction section 90, depending on the prediction mode information included in the PU information (S220).

Next, the feature quantity detection section 631 of the inverse quantization section 63 detects (acquires) feature quantities on the basis of the PU information obtained in step S210 and the predicted image obtained in step S220 (S230). Note that the process in step S230 is similar to the process in step S130 when encoding described with reference to FIG. 6.

Next, the inverse quantization control section 632 of the inverse quantization section 63 specifies a quantization parameter to use for inverse quantization on the basis of the feature quantities detected in step S230, and generates inverse quantization control information including the quantization parameter (S240). Note that details about the process in step S240 will be described later.

Next, the inverse quantization operation section 633 of the inverse quantization section 63 uses the quantization parameter specified by the inverse quantization control section 632 to inversely quantize the quantized coefficients obtained in step S210 and obtain transform coefficients (S250).

Next, the inverse orthogonal transform section 64 performs an inverse orthogonal transform on the transform coefficients obtained in step S250, and obtains prediction error data (S260).

Next, the addition section 65 adds the prediction error data to the predicted image data, and thereby generates decoded image data (S270).

### [5-2. Flow of Inverse Quantization Control Information Generation Process]

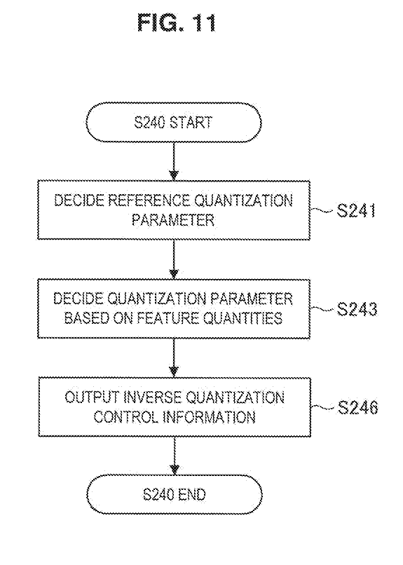

FIG. 11 is a flowchart illustrating a detailed flow of step S240 illustrated in FIG. 10.

Referring to FIG. 11, first, the reference quantization parameter QP is decided (S241). For example, the reference quantization parameter may be decided as a quantization parameter in units of slices by using the quantization parameter in units of pictures and the adjustment value for the quantization parameter in units of slices included among the parameters acquired by the lossless decoding section 62.

Next, the inverse quantization control section 632 decides (specifies) the quantization parameter on the basis of the feature quantities detected in step S230 (S243). At this point, the quantization parameter may be specified according to an inverse quantization control process corresponding to the quantization control process performed during encoding from among the first inverse quantization control process to the third inverse quantization control process described above.

Next, the inverse quantization control section 632 outputs inverse quantization control information including the quantization parameter specified in step S242 to the inverse quantization operation section 633 (S246).

By executing each process as above, the image decoding apparatus 60 is able to specify a quantization parameter and decrease the amount of parameter-related transmission further, without having to receive a differential quantization parameter for adjusting the quantization parameter for each block.

Note that the units of processing for each process described above may be any units, and do not have to be the same as each other. Consequently, the process in each step can also be executed in parallel with the process of another step or the like, or alternatively, the processing order in which to execute the processes may be rearranged.

### <6. Exemplary Hardware Configuration>

The series of processes described above can be executed by hardware, and can also be executed in software. In the case of executing the series of processes by software, a program forming the software is installed on a computer. Herein, the term computer includes a computer built into special-purpose hardware, a computer able to execute various functions by installing various programs thereon, such as a general-purpose personal computer, for example, and the like.

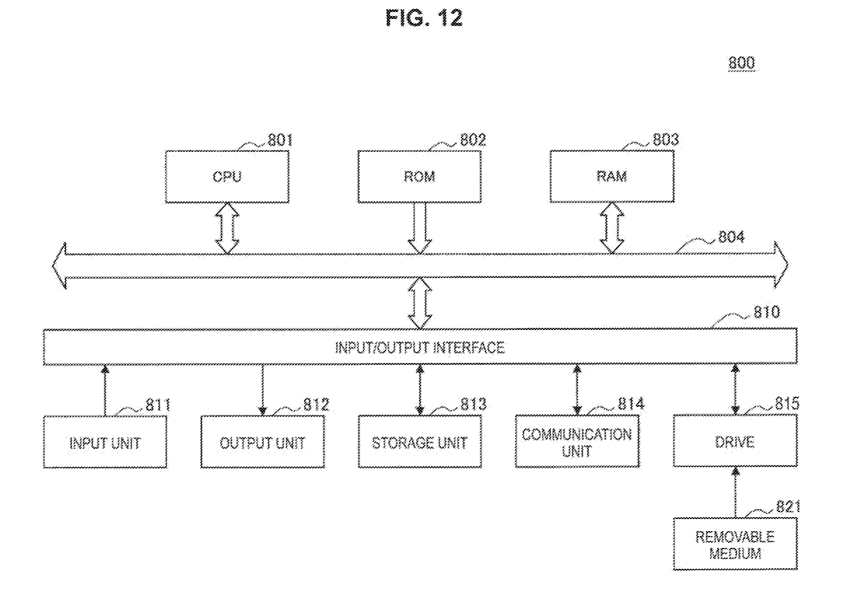

FIG. 12 is a block diagram illustrating an exemplary hardware configuration of a computer that executes the series of processes described above according to a program.

In the computer 800 illustrated in FIG. 12, a central processing unit (CPU) 801, read-only memory (ROM) 802, and random access memory (RAM) 803 are interconnected through a bus 804.

Additionally, an input/output interface 810 is also connected to the bus 804. An input unit 811, an output unit 812, a storage unit 813, a communication unit 814, and a drive 815 are connected to the input/output interface 810.

The input unit 811 includes a keyboard, a mouse, a microphone, a touch panel, an input terminal, and the like, for example. The output unit 812 includes a display, a speaker, an output terminal, and the like, for example. The storage unit 813 includes a hard disk, a RAM disk, non-volatile memory, and the like, for example. The communication unit 814 includes a network interface, for example. The drive 815 drives a removable medium 821 such as a magnetic disk, an optical disc, a magneto-optical disc, or semiconductor memory.

In a computer configured as above, the series of processes described above are performed by having the CPU 801 load a program stored in the storage unit 813 into the RAM 803 via the input/output interface 810 and the bus 804, and execute the program, for example. Additionally, data required for the CPU 801 to execute various processes and the like is also stored in the RAM 803 as appropriate.

The program executed by the computer (CPU 801) may be applied by being recorded onto the removable medium 821 as an instance of packaged media or the like, for example. In this case, the program may be installed in the storage unit 813 via the input/output interface 810 by inserting the removable medium 821 into the drive 815.

In addition, the program may also be provided via a wired or wireless transmission medium such as a local area network, the Internet, or digital satellite broadcasting. In this case, the program may be received by the communication unit 814 and installed in the storage unit 813.

Otherwise, the program may also be preinstalled in the ROM 802 or the storage unit 813.

### <7. Application Examples>

The image encoding apparatus 10 and the image decoding apparatus 60 according to the above-described embodiments can be applied to various electronic apparatuses such as: transmitters or receivers for satellite broadcasting, wired broadcasting such as cable TV, distribution on the Internet and distribution to terminals through cellular communication; recording devices which record images on media such as optical discs, magnetic disks, and flash memories; or reproduction devices which reproduce images from the foregoing storage media.

### (1) First Application Example: Television Receiver

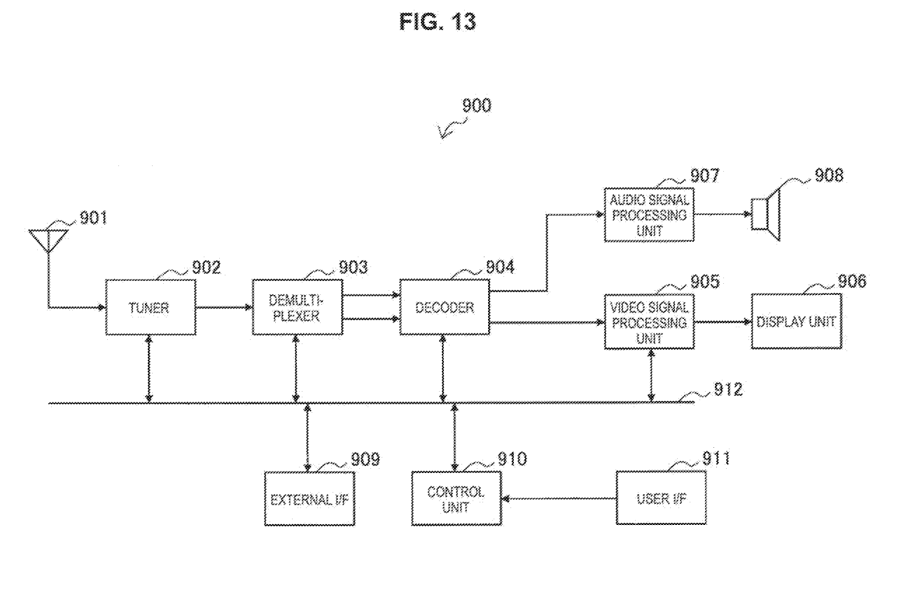

FIG. 13 illustrates an example of a schematic configuration of a television apparatus to which the above-described embodiment is applied. The television apparatus 900 has an antenna 901, a tuner 902, a demultiplexer 903, a decoder 904, a video signal processing unit 905, a display unit 906, an audio signal processing unit 907, a speaker 908, an external interface (UF) 909, a control unit 910, a user interface (UF) 911, and a bus 912.

The tuner 902 extracts a signal of a desired channel from a broadcasting signal received via the antenna 901 and demodulates the extracted signal. Then, the tuner 902 outputs an encoded bit stream obtained from the demodulation to the demultiplexer 903. That is, the tuner 902 plays a role as a transmission section of the television apparatus 900 which receives an encoded stream in which images are encoded.

The demultiplexer 903 demultiplexes a video stream and an audio stream of a program to be viewed from the encoded stream and outputs the demultiplexed streams to the decoder 904. In addition, the demultiplexer 903 extracts auxiliary data such as an electronic program guide (EPG) from the encoded bit stream and supplies the extracted data to the control unit 910. Note that, in the case where the encoded bit stream has been scrambled, the demultiplexer 903 may perform descrambling.

The decoder 904 decodes the video stream and the audio stream input from the demultiplexer 903. Then, the decoder 904 outputs video data generated from the decoding process to the video signal processing unit 905. In addition, the decoder 904 outputs audio data generated from the decoding process to the audio signal processing unit 907.

The video signal processing unit 905 reproduces the video data input from the decoder 904 to cause the display unit 906 to display a video. In addition, the video signal processing unit 905 may cause the display unit 906 to display an application screen supplied via a network. Furthermore, the video signal processing unit 905 may perform an additional process, for example, noise reduction, on the video data in accordance with a setting. Moreover, the video signal processing unit 905 may generate an image of a graphical user interface (GUI), for example, a menu, a button, or a cursor and superimpose the generated image on an output image.

The display unit 906 is driven with a driving signal supplied from the video signal processing unit 905 and displays a video or an image on a video plane of a display device (e.g., a liquid crystal display, a plasma display, an organic electroluminescence display (OLED), etc.).

The audio signal processing unit 907 performs a reproduction process including D/A conversion and amplification on the audio data input from the decoder 904 and causes the speaker 908 to output a sound. In addition, the audio signal processing unit 907 may perform an additional process such as noise removal on the audio data.

The external interface 909 is an interface for connecting the television apparatus 900 to an external apparatus or a network. For example, a video stream or an audio stream received via the external interface 909 may be decoded by the decoder 904. In other words, the external interface 909 also plays the role as a transmission sections of the television apparatus 900 which receives an encoded stream in which images are encoded.

The control unit 910 has a processor such as a CPU and a memory such as a RAM and a ROM. The memory stores a program executed by the CPU, program data, EPG data, and data acquired via a network. The program stored in the memory is read and executed by the CPU at the time of, for example, start-up of the television apparatus 900. The CPU controls operations of the television apparatus 900 by executing the program in response to, for example, operation signals input from the user interface section 911.

The user interface section 911 is connected to the control unit 910. The user interface section 911 includes, for example, buttons and switches with which a user operates the television apparatus 900, a reception unit for remote control signals, and the like. The user interface section 911 generates an operation signal by detecting an operation by a user via any aforementioned constituent element and outputs the generated operation signal to the control unit 910.

The bus 912 connects the tuner 902, the demultiplexer 903, the decoder 904, the video signal processing unit 905, the audio signal processing unit 907, the external interface 909, and the control unit 910 to one another.

In the television apparatus 900 configured in this way, the decoder 904 may also include the functions of the image decoding apparatus 60 described above. In other words, the decoder 904 may be configured to decode encoded data according to the method described in each of the above embodiments. With this arrangement, the television apparatus 900 becomes able to further decrease the amount of transmission related to the transmission (reception) of parameters.

Also, in the television apparatus 900 configured in this way, the video signal processing unit 905 may be able to encode image data provided from the decoder 904, and cause the obtained encoded data to be output externally to the television apparatus 900 through external interface 909. Additionally, the video signal processing unit 905 may also include the functions of the image encoding apparatus 10 described above. In other words, the video signal processing unit 905 may be configured to encode image data provided from the decoder 904 according to the method described in each of the above embodiments. With this arrangement, the television apparatus 900 becomes able to further decrease the amount of transmission related to the transmission (transmission) of parameters.

### (2) Second Application Example: Mobile Telephone

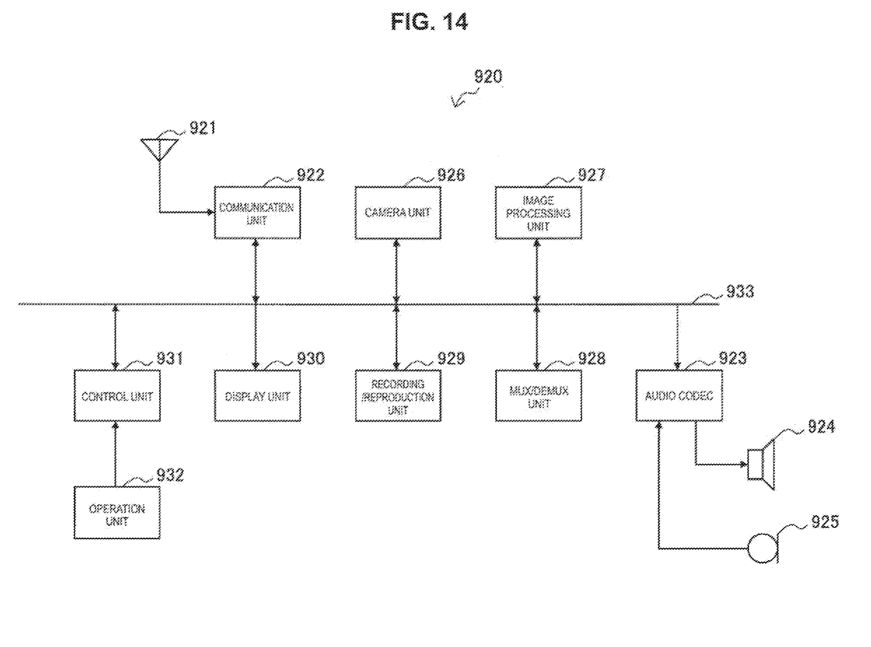

FIG. 14 illustrates an example of a schematic configuration of a mobile telephone to which the above-described embodiments are applied. A mobile telephone 920 includes an antenna 921, a communication unit 922, an audio codec 923, a speaker 924, a microphone 925, a camera unit 926, an image processing unit 927, a multiplexing/demultiplexing unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the multiplexing/demultiplexing unit 928, the recording/reproducing unit 929, the display unit 930, and the control unit 931.

The mobile telephone 920 performs actions such as transmitting/receiving an audio signal, transmitting/receiving an electronic mail or image data, capturing an image, and recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, performs frequency conversion, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then supplies the generated audio signal to the speaker 924 to cause it to output the audio.

In the data communication mode, for example, the control unit 931 generates character data configuring an electronic mail, in accordance with a user operation detected through the operation unit 932. The control unit 931 further displays characters on the display unit 930. Moreover, the control unit 931 generates electronic mail data in accordance with an instruction to send it obtained from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, performs frequency conversion, and acquires a reception signal. The communication unit 922 thereafter demodulates and decodes the reception signal, restores the electronic mail data, and outputs the restored electronic mail data to the control unit 931. The control unit 931 displays the content of the electronic mail on the display unit 930 as well as supplies the electronic mail data to a storage medium of the recording/reproducing unit 929 to cause the data to be recorded in the medium.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB memory, or a memory card.

In the photography mode, for example, the camera unit 926 images an object to generate image data and outputs the generated image data to the image processing unit 927. The image processing unit 927 encodes the image data input from the camera unit 926 and supplies an encoded stream to the storage medium of the recording/reproducing unit 929 to cause the encoded stream to be recorded in the medium.

Furthermore, in the image display mode, the recording/reproducing unit 929 reads out an encoded stream recorded on a storage medium, and outputs to the image processing unit 927. The image processing unit 927 decodes the encoded stream input from the recording/reproducing unit 929, supplies image data to the display unit 930, and causes the image to be displayed.

In the videophone mode, for example, the multiplexing/demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 then transmits the generated transmission signal to the base station (not shown) through the antenna 921. Moreover, the communication unit 922 amplifies a radio signal received through the antenna 921, performs frequency conversion, and acquires a reception signal. The transmission signal and the reception signal can include an encoded bit stream. The communication unit 922 thus demodulates and decodes the reception signal to restore the stream, and outputs the restored stream to the multiplexing/demultiplexing unit 928. The multiplexing/demultiplexing unit 928 demultiplexes the video stream and the audio stream from the input stream and outputs the video stream and the audio stream to the image processing unit 927 and the audio codec 923, respectively. The image processing unit 927 decodes the video stream to generate video data. The video data is then supplied to the display unit 930, which displays a series of images. The audio codec 923 expands and performs D/A conversion on the audio stream to generate an analog audio signal. The audio codec 923 then supplies the generated audio signal to the speaker 924 to cause it to output the audio.

In the mobile telephone 920 configured in this way, the image processing unit 927 may include the functions of the image encoding apparatus 10 described above, for example. In other words, the image processing unit 927 may be configured to encode image data according to the method described in each of the above embodiments. With this arrangement, the mobile telephone 920 becomes able to further decrease the amount of transmission related to the transmission (transmission) of parameters.

In addition, in the mobile telephone 920 configured in this way, the image processing unit 927 may include the functions of the image decoding apparatus 60 described above, for example. In other words, the image processing unit 927 may be configured to decode encoded data according to the method described in each of the above embodiments. With this arrangement, the mobile telephone 920 becomes able to further decrease the amount of transmission related to the transmission (reception) of parameters.

### (3) Third Application Example: Recording/Reproducing Apparatus

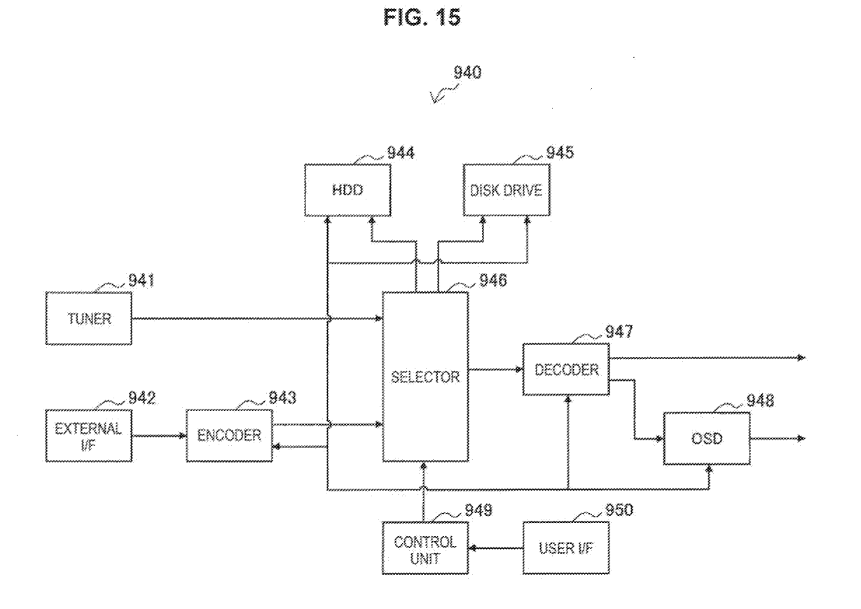

FIG. 15 illustrates an example of a schematic configuration of a recording/reproducing apparatus to which the above-described embodiments are applied. The recording/reproducing apparatus 940 encodes audio data and video data of a received broadcast program and records the data into a recording medium, for example. The recording/reproducing apparatus 940 may also encode audio data and video data acquired from another apparatus and record the data into the recording medium, for example. The recording/reproducing apparatus 940 reproduces the data recorded in the recording medium on a monitor and a speaker, for example, in response to a user instruction. In this case, recording/reproducing apparatus 940 decodes the audio data and the video data.

The recording/reproducing apparatus 940 includes a tuner 941, an external interface 942, an encoder 943, a hard disk drive (HDD) 944, a disk drive 945, a selector 946, a decoder 947, an on-screen display (OSD) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing apparatus 940.

The external interface 942 is an interface which connects the recording/reproducing apparatus 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing apparatus 940.

The encoder 943 encodes the video data and the audio data in the case where the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when the video and the audio are reproduced.

The disk drive 945 records and reads data into/from a recording medium attached to the disk drive. The recording medium attached to the disk drive 945 may be, for example, a DVD disk (such as DVD-Video, DVD-RAM, DVD−R, DVD−RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, buttons, or a cursor onto the displayed video.

The control unit 949 includes a processor such as a CPU and a memory such as a RAM and a ROM. The memory stores a program executed by the CPU as well as program data. The program stored in the memory is read by the CPU at the start-up of the recording/reproducing apparatus 940 and executed, for example. By executing the program, the CPU controls the operation of the recording/reproducing apparatus 940 in accordance with an operation signal that is input from the user interface 950, for example.

The user interface 950 is connected to the control unit 949. The user interface 950 includes a button and a switch for a user to operate the recording/reproducing apparatus 940 as well as a reception part which receives a remote control signal, for example. The user interface 950 detects a user operation through these components to generate an operation signal, and outputs the generated operation signal to the control unit 949.

In the recording/reproducing apparatus 940 configured in this way, the encoder 943 includes the functions of the image encoding apparatus 10 according to the embodiments described above. In addition, the decoder 947 includes the functions of the image decoding apparatus 60 according to the embodiments described above. With this arrangement, when the recording/reproducing apparatus 940 becomes able to further decrease the amount of transmission related to parameters.

### (4) Fourth Application Example: Imaging Apparatus

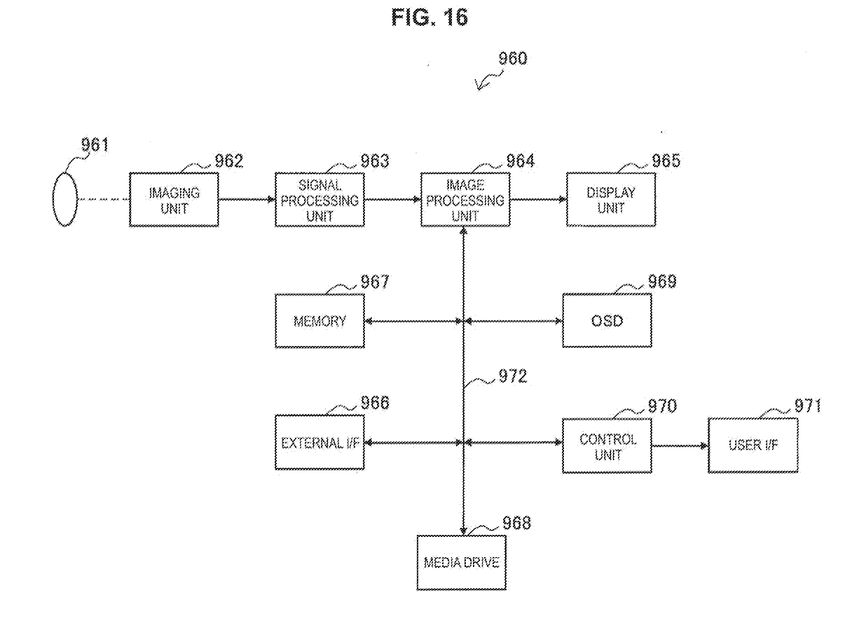

FIG. 16 illustrates an example of a schematic configuration of an imaging apparatus to which the above-described embodiments are applied. The imaging apparatus 960 images an object to generate an image, encodes image data, and records the data into a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of an object on an imaging plane of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging plane into an image signal as an electric signal. Then, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal processes have been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display unit 965. Moreover, the image processing unit 964 may output to the display unit 965 the image data input from the signal processing unit 963 to cause the display unit 965 to display the image. Furthermore, the image processing unit 964 may superpose display data acquired from the OSD 969 onto the image that is output on the display unit 965.

The OSD 969 generates an image of a GUI such as a menu, buttons, or a cursor and outputs the generated image to the image processing unit 964.

The external interface 966 is configured as a USB input/output terminal, for example. The external interface 966 connects the imaging apparatus 960 with a printer when printing an image, for example. Moreover, a drive is connected to the external interface 966 as needed. A removable medium such as a magnetic disk or an optical disk is attached to the drive, for example, so that a program read from the removable medium can be installed to the imaging apparatus 960. The external interface 966 may also be configured as a network interface that is connected to a network such as a LAN or the Internet. That is, the external interface 966 has a role as transmission means in the imaging apparatus 960.

The recording medium attached to the media drive 968 may be an arbitrary removable medium that is readable and writable such as a magnetic disk, a magneto-optical disk, an optical disk, or a semiconductor memory. Furthermore, the recording medium may be attached to the media drive 968 in a fixed manner so that a non-transportable storage unit such as a built-in hard disk drive or a solid state drive (SSD) is configured, for example.

The control unit 970 includes a processor such as a CPU and a memory such as a RAM and a ROM. The memory stores a program executed by the CPU as well as program data. The program stored in the memory is read by the CPU at the start-up of the imaging apparatus 960 and then executed. By executing the program, the CPU controls the operation of the imaging apparatus 960 in accordance with an operation signal that is input from the user interface 971, for example.

The user interface 971 is connected to the control unit 970. The user interface 971 includes buttons and switches for a user to operate the imaging apparatus 960, for example. The user interface 971 detects a user operation through these components to generate an operation signal, and outputs the generated operation signal to the control unit 970.

In the imaging apparatus 960 configured in this way, the image processing unit 964 includes the functions of the image encoding apparatus 10 and the image decoding apparatus 60 according to the embodiments described above. With this arrangement, when the imaging apparatus 960 becomes able to further decrease the amount of transmission related to parameters.

### (5) Fifth Application Example: Video Set

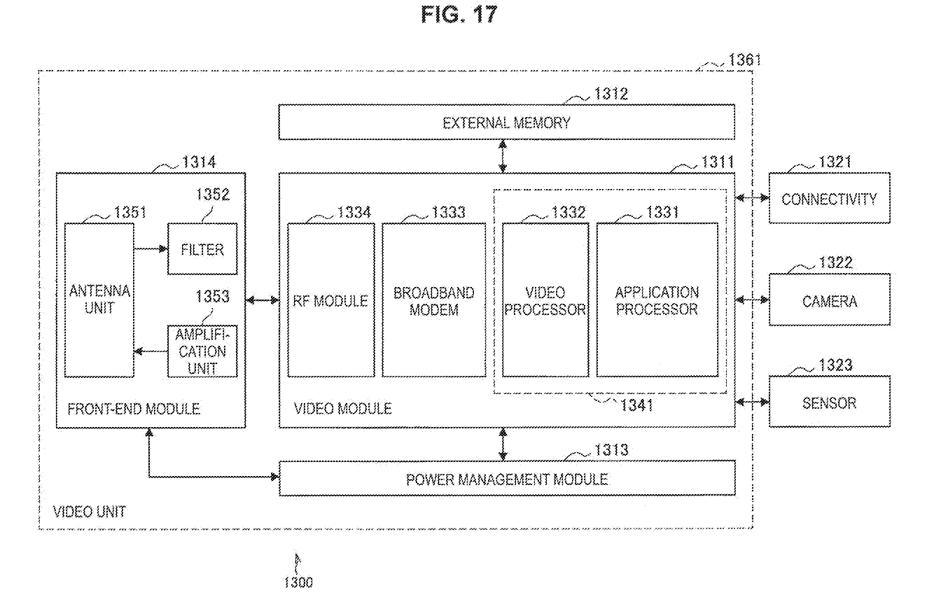

Additionally, the present technology may also be implemented as any kind of configuration installed in any apparatus or an apparatus included in a system, such as a processor provided as a large-scale integration (LSI) chip or the like, a module that uses multiple processors or the like, a unit that uses multiple modules or the like, a set that further adds other functions to a unit (that is, a configuration of a part of an apparatus), or the like. FIG. 17 illustrates one example of a schematic configuration of a video set applying the present technology.

Recently, electronic devices are becoming more multifunctional, and in the development and manufacture of such electronic devices, in the case of implementing a partial configuration thereof for sale, offer, or the like, it has become commonplace not only to carry out the implementation as a configuration that includes a single function, but also to combine multiple configurations that include related functions and carry out the implementation as a single set including multiple functions.

The video set 1300 illustrated in FIG. 17 is such a multifunctional configuration, and is a combination of a device that includes functions related to image encoding and decoding (either one, or both) with a device that includes other functions related to such functions.

As illustrated in FIG. 17, the video set 1300 includes a module group such as a video module 1311, external memory 1312, a power management module 1313, and a front-end module 1314, and a device that includes related functions such as connectivity 1321, a camera 1322, and a sensor 1323.

A module is a part that collects several interrelated partial functions into a unified function. The specific physical configuration may be any configuration, but for example, it is conceivable to dispose and integrate multiple processors with respective functions, electronic circuit elements such as resistors and capacitors, other devices, and the like onto a circuit board or the like. It is also conceivable to combine a module with another module, processor, or the like to create a new module.

In the case of the example in FIG. 17, the video module 1311 is a combination of configurations that include functions related to image processing, and includes an application processor, a video processor, a broadband modem 1333, and an RF module 1334.

The processor is an integration of configurations having predetermined functions into a semiconductor chip as a system on a chip (SoC), and may also be designated a large-scale integration (LSI) chip or the like, for example. The configurations having predetermined functions may be logic circuits (hardware configurations), but may also be a CPU, ROM, RAM, and the like as well as a program executed using these (software configurations), and may also be a combination of both. For example, a processor may include logic circuits and CPU, ROM, RAM, and the like, and may be configured to realize a subset of the functions with the logic circuits (hardware configurations) while realizing other functions with programs (software configurations) executed on the CPU.

The application processor 1331 in FIG. 17 is a processor that executes an application related to image processing. To realize a predetermined function, the application executed in the application processor 1331 is able to not only execute computational processing, but is also able to control configurations inside and outside the video module 1311, such as the video processor 1332, for example, as necessary.

The video processor 1332 is a processor that includes functions related to image encoding/decoding (either one, or both).

The broadband modem 1333 performs digital modulation and the like to convert data (a digital signal) transmitted by wired or wireless (or both) broadband communication performed over a broadband connection such as the Internet or the public telephone network into an analog signal, and also performs demodulation to convert an analog signal received by such broadband communication into data (a digital signal). The broadband modem 1333 processes any kind of information, such as image data processed by the video processor 1332, a stream in which image data is encoded, application programs, and settings data, for example.

The RF module 1334 is a module that performs frequency conversion, modulation/demodulation, amplification, filter processing, and the like on radio frequency (RF) signals transmitted and received through an antenna. For example, the RF module 1334 generates an RF signal by performing frequency conversion and the like on a baseband signal generated by the broadband modem 1333. Also, for example, the RF module 1334 generates a baseband signal by performing frequency conversion and the like on an RF signal received via the front-end module 1314.

Note that as illustrated by the dashed line 1341 in FIG. 17, the application processor 1331 and the video processor 1332 may also be unified and configured as a single processor.

The external memory 1312 is a module provided externally to the video module 1311 that includes a storage device utilized by the video module 1311. The storage device of the external memory 1312 may be realized by any kind of physical configuration, but since the storage device typically is used to store large amounts of data such as image data in units of frames, it is desirable to realize the storage device with relatively inexpensive and high-capacity semiconductor memory such as dynamic random access memory (DRAM), for example.

The power management module 1313 manages and controls the supply of power to the video module 1311 (each configuration inside the video module 1311).

The front-end module 1314 is a module that provides a front-end function (a circuit on the antenna-side transmit/receive port) to the RF module 1334. As illustrated in FIG. 17, the front-end module 1314 includes an antenna unit 1351, a filter 1352, and an amplification unit 1353, for example.

The antenna unit 1351 includes an antenna that transmits and receives wireless signals, and a peripheral configuration thereof. The antenna unit 1351 transmits a signal supplied from the amplification unit 1353 as a wireless signal, and supplies a received wireless signal to the filter 1352 as an electric signal (RF signal). The filter 1352 performs filter processing and the like on the RF signal received through the antenna unit 1351, and supplies the processed RF signal to the RF module 1334. The amplification unit 1353 amplifies and supplies the RF signal supplied from the RF module 1334 to the antenna unit 1351.

The connectivity 1321 is a module that includes functions related to external connections. The physical configuration of the connectivity 1321 may be any configuration. For example, the connectivity 1321 includes a configuration having a communication function other than the communication standard supporting by the broadband modem 1333, an external input/output terminal, or the like.

For example, the connectivity 1321 may include a module having a communication function conforming to a wireless communication standard such as Bluetooth(registered trademark), IEEE 802.11 (for example, Wireless Fidelity (Wi-Fi(registered trademark))), near field communication (NFC), or Infrared Data Association (IrDA), and an antenna or the like that transmits and receives signals conforming to the standard. Also, for example, the connectivity 1321 may include a module having a communication function conforming to a wired communication function such as Universal Serial Bus (USB) or High-Definition Multimedia Interface (HDMI)(registered trademark), and a port conforming to the standard. Furthermore, for example, the connectivity 1321 may include a function of transmitting another kind of data (signal), such as an analog input/output terminal.

Note that the connectivity 1321 may include the transmission destination device of the data (signal). For example, the connectivity 1321 may include a drive (not only a drive for removable media, but also including a hard disk, a solid-state drive (SSD), network-attached storage (NAS), and the like) that reads and writes data with respect to a recording medium such as a magnetic disk, an optical disc, a magneto-optical disc, or semiconductor memory. Also, the connectivity 1321 may include devices (such as a monitor and a speaker) that output images and sound.

The camera 1322 is a module that has a function of imaging a subject and obtaining image data of the subject. The image data obtained by the imaging by the camera 1322 is supplied to the video processor 1332 and encoded, for example.

The sensor 1323 is a module having any type of sensor function, such as a sound sensor, an ultrasonic sensor, a light sensor, an illumination sensor, an infrared sensor, an image sensor, a rotation sensor, an angle sensor, an angular velocity sensor, a speed sensor, an acceleration sensor, an inclination sensor, a magnetic field sensor, a shock sensor, or a temperature sensor, for example. Data detected by the sensor 1323 is supplied to the application processor 1331 and utilized by an application and the like, for example.

The configurations described as a module above may also be realized as a processor, while conversely, the configurations described as a processor may also be realized as a module.

In the video set 1300 with a configuration like the above, the present technology can be applied to the video processor 1332 as described later. Consequently, the video set 1300 may be carried out as a set applying the present technology.

### (Exemplary Configuration of Video Processor)

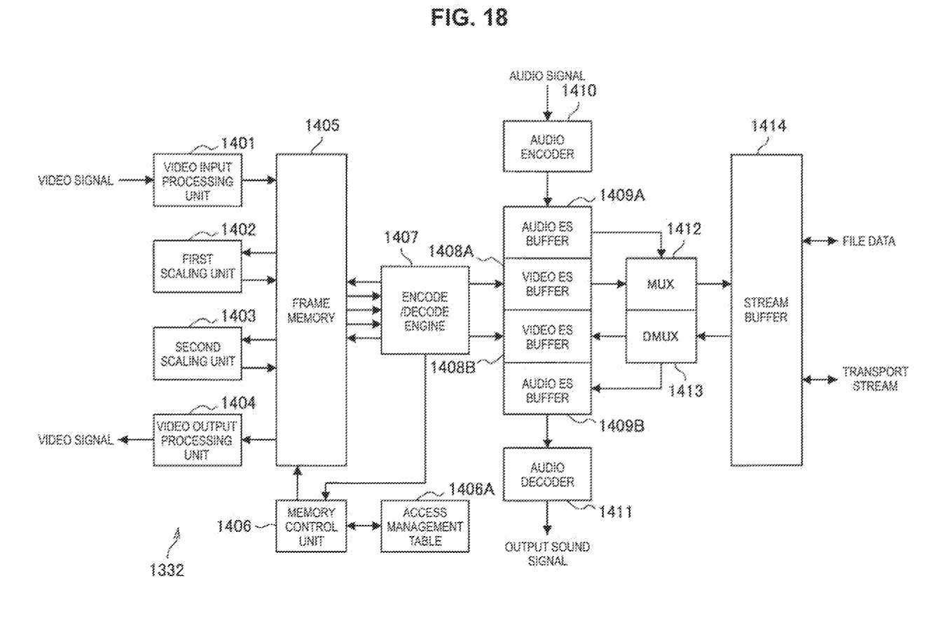

FIG. 18 illustrates one example of a schematic configuration of the video processor 1332 (FIG. 17) applying the present technology.

In the case of the example in FIG. 18, the video processor 1332 includes a function of receiving the input of a video signal and an audio signal and encoding these signals according to a predetermined method, and a function of decoding encoded video data and audio data, and reproducing and outputting a video signal and an audio signal.

As illustrated in FIG. 18, the video processor 1332 includes a video input processing unit 1401, a first image enlargement/reduction unit 1402, a second image enlargement/reduction unit 1403, a video output processing unit 1404, frame memory 1405, and a memory control unit 1406. Also, the video processor 1332 includes an encode/decode engine 1407, video elementary stream (ES) buffers 1408A and 1408B, and audio ES buffers 1409A and 1409B. Additionally, the video processor 1332 includes an audio encoder 1410, an audio decoder 1411, a multiplexer (MUX) 1412, a demultiplexer (DMUX) 1413, and a stream buffer 1414.

The video input processing unit 1401 acquires a video signal input from the connectivity 1321 (FIG. 17) or the like, for example, and converts the video signal into digital image data. The first image enlargement/reduction unit 1402 performs format conversion, image enlargement/reduction processing, and the like on the image data. The second image enlargement/reduction unit 1403 performs a process of enlarging or reducing the image according to the format at the destination to which to output through the video output processing unit 1404, format conversion and image enlargement/reduction processing similar to the first image enlargement/reduction unit 1402, and the like on the image data. The video output processing unit 1404 performs format conversion, conversion to an analog signal, and the like on the image data, and outputs the result to the connectivity 1321 for example as a reproduced video signal.

The frame memory 1405 is memory for image data shared by the video input processing unit 1401, the first image enlargement/reduction unit 1402, the second image enlargement/reduction unit 1403, the video output processing unit 1404, and the encode/decode engine 1407. The frame memory 1405 is realized as semiconductor memory such as DRAM, for example.

The memory control unit 1406 receives a synchronization signal from the encode/decode engine 1407, and controls the access and writes and reads to the frame memory 1405 in accordance with an access schedule of access to the frame memory 1405 written in an access management table 1406A. The access management table 1406A is updated by the memory control unit 1406 according to processes executed by the encode/decode engine 1407, the first image enlargement/reduction unit 1402, the second image enlargement/reduction unit 1403, and the like.

The encode/decode engine 1407 executes a process of encoding image data as well as a process of decoding a video stream, which is data in which image data is encoded. For example, the encode/decode engine 1407 encodes image data read from the frame memory 1405, and successively writes the encoded data to the video ES buffer 1408A as a video stream. Also, for example, the encode/decode engine 1407 successively reads and decodes a video stream from the video ES buffer 1408B, and writes the decoded data to the frame memory 1405 as image data. During this encoding and decoding, the encode/decode engine 1407 uses the frame memory 1405 as a work area. Also, the encode/decode engine 1407 outputs a synchronization signal to the memory control unit 1406 at the timing of starting the process for each macroblock, for example.

The video ES buffer 1408A buffers and supplies a video stream generated by the encode/decode engine 1407 to the multiplexer (MUX) 1412. The video ES buffer 1408B buffers and supplies a video stream supplied from the demultiplexer (DMUX) 1413 to the encode/decode engine 1407.

The audio ES buffer 1409A buffers and supplies an audio stream generated by the audio encoder 1410 to the multiplexer (MUX) 1412. The audio ES buffer 1409B buffers and supplies an audio stream supplied from the demultiplexer (DMUX) 1413 to the audio decoder 1411.

The audio encoder 1410 for example digitally converts an audio signal input from the connectivity 1321 or the like, for example, and encodes the audio signal according to a predetermined method such as the MPEG Audio method or the AudioCode number 3 (AC 3) method, for example. The audio encoder 1410 successively writes an audio stream, which is data in which an audio signal is encoded, to the audio ES buffer 1409A. The audio decoder 1411 decodes an audio stream supplied from the audio ES buffer 1409B, performs conversion to an analog signal and the like, for example, and supplies the result to the connectivity 1321 and the like for example as a reproduced audio signal.

The multiplexer (MUX) 1412 multiplexes a video stream and an audio stream. The multiplexing method (that is, the format of the bit stream generated by multiplexing) may be any method. Additionally, during this multiplexing, the multiplexer (MUX) 1412 is also able to add predetermined header information or the like to the bit stream. In other words, the multiplexer (MUX) 1412 is able to convert the format of the streams by multiplexing. For example, by multiplexing a video stream and an audio stream, the multiplexer (MUX) 1412 converts the streams to a transport stream, which is a bit stream in a format for transmission. Also, for example, by multiplexing a video stream and an audio stream, the multiplexer (MUX) 1412 converts the streams to data (file data) in a file format for recording.

The demultiplexer (DMUX) 1413 demultiplexes a bit stream in which a video stream and an audio stream are multiplexed, according to a method corresponding to the multiplexed by the multiplexer (MUX) 1412. In other words, the demultiplexer (DMUX) 1413 extracts the video stream and the audio stream (separates the video stream and the audio stream) from a bit stream read out from the stream buffer 1414. In other words, the demultiplexer (DMUX) 1413 is able to convert the format of the stream by demultiplexing (an inverse conversion of the conversion by the multiplexer (MUX) 1412). For example, the demultiplexer (DMUX) 1413 is able to acquire a transport stream supplied from the connectivity 1321, the broadband modem 1333, or the like for example via the stream buffer 1414, and by demultiplexing, is able to convert the transport stream into a video stream and an audio stream. Also, for example, the demultiplexer (DMUX) 1413 is able to acquire file data read out from any of various types of recording media by the connectivity 1321, for example via the stream buffer 1414, and by demultiplexing, is able to convert the file data into a video stream and an audio stream.

The stream buffer 1414 buffers a bit stream. For example, the stream buffer 1414 buffers a transport stream supplied from the multiplexer (MUX) 1412, and at a predetermined timing, or on the basis of an external request or the like, supplies the transport stream to the connectivity 1321, the broadband modem 1333, or the like, for example.

Also, for example, the stream buffer 1414 buffers file data supplied from the multiplexer (MUX) 1412, and at a predetermined timing, or on the basis of an external request or the like, supplies the file data to the connectivity 1321 or the like, for example, and causes the file data to be recorded on any of various types of recording media.

Furthermore, the stream buffer 1414 buffers a transport stream acquired via the connectivity 1321, the broadband modem 1333, and the like, for example, and at a predetermined timing, or on the basis of an external request or the like, supplies the transport stream to the demultiplexer (DMUX) 1413.

Additionally, the stream buffer 1414 buffers file data read out from any of various types of recording media in the connectivity 1321 or the like, for example, and at a predetermined timing, or on the basis of an external request or the like, supplies the file data to the demultiplexer (DMUX) 1413.

Next, an example of the operation of the video processor 1332 with such a configuration will be described. For example, a video signal input into the video processor 1332 from the connectivity 1321 or the like is converted to digital image data of a predetermined format such as 4:2:2 Y/Cb/Cr format in the video input processing unit 1401, and is successively written to the frame memory 1405. The digital image data is read out to the first image enlargement/reduction unit 1402 or the second image enlargement/reduction unit 1403, subjected to a format conversion to a predetermined format such as 4:2:0 Y/Cb/Cr or the like and an enlargement/reduction process, and again written to the frame memory 1405. The image data is encoded by the encode/decode engine 1407, and written to the video ES buffer 1408A as a video stream.

Also, an audio signal input into the video processor 1332 from the connectivity 1321 or the like is encoded by the audio encoder 1410, and written to the audio ES buffer 1409A as an audio stream.

The video stream in the video ES buffer 1408A and the audio stream in the audio ES buffer 1409A are read out and multiplexed by the multiplexer (MUX) 1412, and converted to a transport stream, file data, or the like. The transport stream generated by the multiplexer (MUX) 1412 is buffered in the stream buffer 1414, and then output to an external network via the connectivity 1321, the broadband modem 1333, or the like, for example. Also, the file data generated by the multiplexer (MUX) 1412 is buffered in the stream buffer 1414, and then output to the connectivity 1321 or the like, for example, and recorded to any of various types of recording media.

Also, a transport stream input into the video processor 1332 from an external network via the connectivity 1321, the broadband modem 1333, or the like for example is buffered in the stream buffer 1414, and then demultiplexed by the demultiplexer (DMUX) 1413. Also, file data read out from any of various types of recording media in the connectivity 1321 or the like, for example, and input into the video processor 1332 is buffered in the stream buffer 1414, and then demultiplexed by the demultiplexer (DMUX) 1413. In other words, a transport stream or file data input into the video processor 1332 is separated into a video stream and an audio stream by the demultiplexer (DMUX) 1413.

The audio stream is supplied to the audio decoder 1411 via the audio ES buffer 1409B and decoded, and an audio signal is reproduced. Also, the video stream, after being written to the video ES buffer 1408B, is successively read out and decoded by the encode/decode engine 1407, and written to the frame memory 1405. The decoded image data is subjected to an enlargement/reduction process by the second image enlargement/reduction unit 1403, and written to the frame memory 1405. Subsequently, the decoded image data is read out to the video output processing unit 1404, format-converted to a predetermined format such as 4:2:2 Y/Cb/Cr format, additionally converted to an analog signal, and a video signal is reproduced and output.

In the case of applying the present technology to the video processor 1332 configured in this way, it is sufficient to apply the present technology according to the embodiments described above to the encode/decode engine 1407. In other words, for example, the encode/decode engine 1407 may include the functions of the image encoding apparatus 10 or the functions of the image decoding apparatus 60 described above, or both. With this arrangement, the video processor 1332 is able to obtain effects similar to each of the embodiments described above with reference to FIGS. 1 to 11.

Note that in the encode/decode engine 1407, the present technology (that is, the functions of the image encoding apparatus 10, the functions of the image decoding apparatus 60, or both) may be realized by hardware such as a logic circuit or the like, may be realized by software such as an embedded program, or may be realized by both of the above.

### (Another Exemplary Configuration of Video Processor)

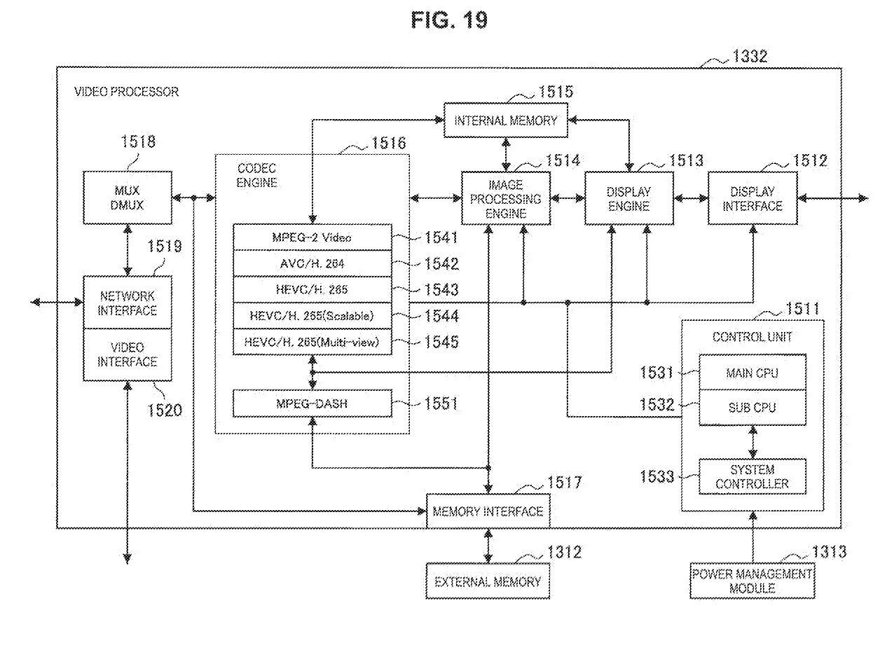

FIG. 19 illustrates another example of a schematic configuration of the video processor 1332 applying the present technology. In the case of the example in FIG. 19, the video processor 1332 includes a function of encoding/decoding video data according to a predetermined method.

More specifically, as illustrated in FIG. 19, the video processor 1332 includes a control unit 1511, a display interface 1512, a display engine 1513, an image processing engine 1514, and internal memory 1515. Also, the video processor 1332 includes a codec engine 1516, a memory interface 1517, a multiplexer/demultiplexer (MUX DMUX) 1518, a network interface 1519, and a video interface 1520.

The control unit 1511 controls the operation of each processing unit in the video processor 1332, such as the display interface 1512, the display engine 1513, the image processing engine 1514, and the codec engine 1516.

As illustrated in FIG. 19, the control unit 1511 includes a main CPU 1531, a sub CPU 1532, and a system controller 1533, for example. The main CPU 1531 executes a program or the like for controlling the operation of each processing unit in the video processor 1332. The main CPU 1531 generates control signals in accordance with the program or the like, and supplies the control signals to each processing unit (in other words, controls the operation of each processing unit). The sub CPU 1532 fulfills a supplementary role to the main CPU 1531. For example, the sub CPU 1532 executes child processes, subroutines, and the like of the program or the like executed by the main CPU 1531. The system controller 1533 controls the operations of the main CPU 1531 and the sub CPU 1532, such as specifying programs to be executed by the main CPU 1531 and the sub CPU 1532.

The display interface 1512, under control by the control unit 1511, outputs image data to the connectivity 1321 and the like, for example. For example, the display interface 1512 converts digital image data to an analog signal and outputs an analog signal, or outputs the digital image data directly, as a reproduced video signal to a monitor apparatus or the like of the connectivity 1321.

The display engine 1513, under control by the control unit 1511, performs various conversion processes such as format conversion, size conversion, and gamut conversion on the image data to match the hardware specs of the monitor apparatus or the like that is to display the image.

The image processing engine 1514, under control by the control unit 1511 performs predetermined image processing on the image data, such as filter processing for improving image quality, for example.

The internal memory 1515 is memory provided inside the video processor 1332, and shared by the display engine 1513, the image processing engine 1514, and the codec engine 1516. For example, the internal memory 1515 is used to exchange data between the display engine 1513, the image processing engine 1514, and the codec engine 1516. For example, the internal memory 1515 stores data supplied from the display engine 1513, the image processing engine 1514, or the codec engine 1516, and as necessary (for example, in response to a request), supplies the data to the display engine 1513, the image processing engine 1514, or the codec engine 1516. The internal memory 1515 may be realized by any kind of storage device, but since the storage device typically is used to store small amounts of data such as image data in units of blocks, parameters, and the like, it is desirable to realize the storage device with semiconductor memory that is relatively (for example, compared to the external memory 1312) small in capacity but has a fast response speed, such as static random access memory (SRAM), for example.

The codec engine 1516 executes processes related to the encoding and decoding of image data. The encoding/decoding method supported by the codec engine 1516 may be any method, and there may be one or multiple such methods. For example, the codec engine 1516 may be provided with a codec function for multiple encoding/decoding methods, and may be configured to encode or decode image data by selecting from among the multiple methods.

In the example illustrated in FIG. 19, the codec engine 1516 includes MPEG-2 Video 1541, AVC/H.264 1542, HEVC/H.265 1543, HEVC/H.265 (Scalable) 1544, HEVC/H.265 (Multi-view) 1545, and MPEG-DASH 1551 as function blocks of codec-related processing, for example.

The MPEG-2 Video 1541 is a function block that encodes and decodes image data according to the MPEG-2 method. The AVC/H.264 1542 is a function block that encodes and decodes image data according to the AVC method. The HEVC/H.265 1543 is a function block that encodes and decodes image data according to the HEVC method. The HEVC/H. 265 (Scalable) 1544 is a function block that scalably encodes and scalably decodes image data according to the HEVC method. The HEVC/H.265 (Multi-view) 1545 is a function block that multi-view encodes and multi-view decodes image data according to the HEVC method.

The MPEG-DASH 1551 is a function block that transmits and receives image data according to the MPEG Dynamic Adaptive Streaming over HTTP (MPEG-DASH) method. MPEG-DASH is a technology that uses the Hypertext Transfer Protocol (HTTP) to stream video, one feature of which being that appropriate encoded data is selected and transmitted in units of segments from among multiple sets of encoded data having different resolutions or the like prepared in advance. The MPEG-DASH 1551 executes the generation, transmission control, and the like of a stream conforming to the standard, while for the encoding/decoding of image data, the MPEG-2 Video 1541 to the HEVC/H.265 (Multi-view) 1545 are used.

The memory interface 1517 is an interface for the external memory 1312. Data supplied from the image processing engine 1514 and the codec engine 1516 is supplied to the external memory 1312 through the memory interface 1517. Also, data read out from the external memory 1312 is supplied to the video processor 1332 (the image processing engine 1514 or the codec engine 1516) through the memory interface 1517.

The multiplexer/demultiplexer (MUX DMUX) 1518 multiplexes and demultiplexes various image-related data, such as a bit stream of encoded data, image data, a video signal, and the like. The multiplexing/demultiplexing method may be any method. For example, when multiplexing, the multiplexer/demultiplexer (MUX DMUX) 1518 is not only able to collect multiple pieces of data into a single piece of data, but also add predetermined header information and the like to the data. Also, when demultiplexing, the multiplexer/demultiplexer (MUX DMUX) 1518 is not only able to divide a single piece of data into multiple pieces of data, but also add predetermined header information and the like to each divided piece of data. In other words, the multiplexer/demultiplexer (MUX DMUX) 1518 is able to convert the format of data by multiplexing/demultiplexing. For example, by multiplexing a bit stream, the multiplexer/demultiplexer (MUX DMUX) 1518 is able to convert the bit stream to a transport stream, which is a bit stream in a format for transmission, or to data in a file format (file data) for recording. Obviously, by demultiplexing, the inverse conversion is also possible.

The network interface 1519 is an interface for the broadband modem 1333, the connectivity 1321, and the like, for example. The video interface 1520 is an interface for the connectivity 1321, the camera 1322, and the like, for example.

Next, an example of the operation of such a video processor 1332 will be described. For example, when a transport stream is received from an external network through the connectivity 1321, the broadband modem 1333, or the like, the transport stream is supplied to the multiplexer/demultiplexer (MUX DMUX) 1518 through the network interface 1519 and demultiplexed, and decoded by the codec engine 1516. The image data obtained by the decoding of the codec engine 1516 is, for example, subjected to predetermined image processing by the image processing engine 1514, subjected to a predetermined conversion by the display engine 1513, supplied to the connectivity 1321 or the like for example through the display interface 1512, and the image is displayed on a monitor. Also, for example, the image data obtained by the decoding of the codec engine 1516 is re-encoded by the codec engine 1516, multiplexed and converted to file data by the multiplexer/demultiplexer (MUX DMUX) 1518, output to the connectivity 1321 or the like for example through the video interface 1520, and recorded on any of various types of recording media.

Furthermore, for example, file data of encoded data in which image data is encoded that is read out from a recording medium not illustrated by the connectivity 1321 or the like is supplied to the multiplexer/demultiplexer (MUX DMUX) 1518 through the video interface 1520 and demultiplexed, and decoded by the codec engine 1516. The image data obtained by the decoding of the codec engine 1516 is subjected to predetermined image processing by the image processing engine 1514, subjected to a predetermined conversion by the display engine 1513, supplied to the connectivity 1321 or the like for example through the display interface 1512, and the image is displayed on a monitor. Also, for example, the image data obtained by the decoding of the codec engine 1516 is re-encoded by the codec engine 1516, multiplexed and converted to a transport stream by the multiplexer/demultiplexer (MUX DMUX) 1518, supplied to the connectivity 1321, the broadband modem 1333, or the like for example through the network interface 1519, and transmitted to another apparatus not illustrated.

Note that the exchange of image data and other data between each of the processing units inside the video processor 1332 is performed by utilizing the internal memory 1515 and the external memory 1312, for example. Additionally, the power management module 1313 controls the supply of power to the control unit 1511, for example.

In the case of applying the present technology to the video processor 1332 configured in this way, it is sufficient to apply the present technology according to the embodiments described above to the codec engine 1516. In other words, for example, it is sufficient for the codec engine 1516 to include the functions of the image encoding apparatus 10 or the functions of the image decoding apparatus 60 described above, or both. With this arrangement, the video processor 1332 is able to obtain effects similar to each of the embodiments described above with reference to FIGS. 1 to 11.

Note that in the codec engine 1516, the present technology (that is, the functions of the image encoding apparatus 10) may be realized by hardware such as a logic circuit or the like, may be realized by software such as an embedded program, or may be realized by both of the above.

The above illustrates two configurations of the video processor 1332 as examples, but the configuration of the video processor 1332 may be any configuration, and may be a configuration other than the two examples described above. Also, the video processor 1332 may be configured as a single semiconductor chip, but may also be configured as multiple semiconductor chips. For example, a three-dimensionally stacked LSI chip in which multiple semiconductors are stacked is possible. Also, a configuration realized by multiple LSI chips is possible.

### (Example of Application to Apparatus)

The video set 1300 can be embedded into any of various types of apparatus that process image data. For example, the video set 1300 can be embedded into the television apparatus 900 (FIG. 13), the mobile telephone 920 (FIG. 14), the recording/reproducing apparatus 940 (FIG. 15), the imaging apparatus 960 (FIG. 16), and the like. By embedding the video set 1300, the apparatus is able to obtain effects similar to each of the embodiments described above with reference to FIGS. 1 to 15.

Note that as long as the video processor 1332 is included, even a part of each configuration of the video set 1300 described above can be carried out as a configuration applying the present technology. For example, it is possible to carry out only the video processor 1332 as a video processor applying the present technology. Also, for example, the processor illustrated by the dashed line 1341 as described above, the video module 1311, and the like can be carried out as a processor, module, or the like applying the present technology. Furthermore, for example, the video module 1311, the external memory 1312, the power management module 1313, and the front-end module 1314 can also be combined and carried out as a video unit 1361 applying the present technology. With any of these configurations, it is possible to obtain effects similar to each of the embodiments described above with reference to FIGS. 1 to 11.

In other words, as long as the video processor 1332 is included, any type of configuration can be embedded into any of various types of apparatus that process image data, similarly to the case of the video set 1300. For example, the video processor 1332, the processor illustrated by the dashed line 1341, the video module 1311, or the video unit 1361 can be embedded into the television apparatus 900 (FIG. 13), the mobile telephone 920 (FIG. 14), the recording/reproducing apparatus 940 (FIG. 15), the imaging apparatus 960 (FIG. 16), and the like. Additionally, by embedding any configuration applying the present technology, the apparatus is able to obtain effects similar to each of the embodiments described above with reference to FIGS. 1 to 11, similarly to the video set 1300.

### (6) Sixth Application Example: Network System

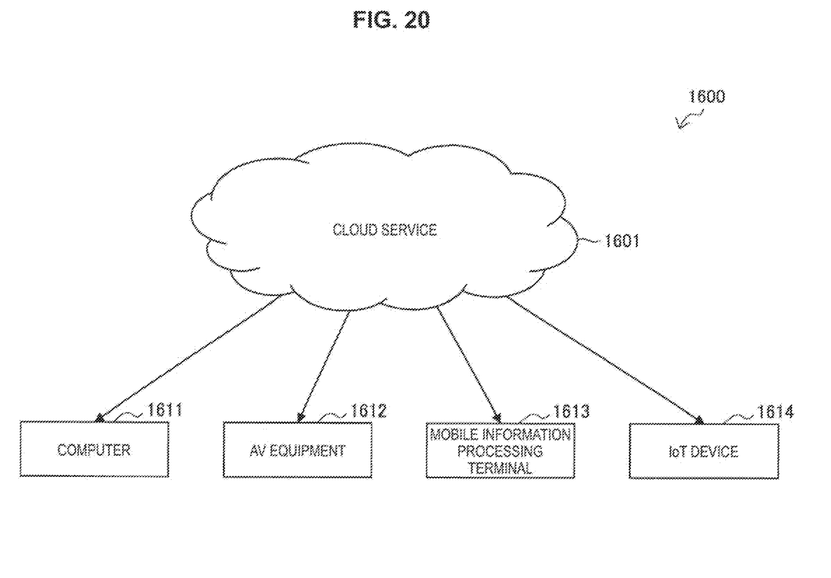

Additionally, the present technology is also applicable to a network system that includes multiple apparatus. FIG. 20 illustrates one example of a schematic configuration of a network system applying the present technology.

The network system 1600 illustrated in FIG. 20 is a system in which devices exchange information related to images (moving images) with each other over a network. The cloud service 1601 of the network system 1600 is a system that provides a service related to images (moving images) to terminals such as a computer 1611, audio-visual (AV) equipment 1612, a mobile information processing terminal 1613, and an Internet of Things (IoT) device 1614 communicably connected to the cloud service 1601. For example, the cloud service 1601 provides a service of supplying image (moving image) content to terminals, like what is called video streaming (on-demand or live streaming). As another example, the cloud service 1601 provides a backup service that receives and stores image (moving image) content from terminals. As another example, the cloud service 1601 provides a service of mediating the exchange of image (moving image) content between terminals.

The physical configuration of the cloud service 1601 may be any configuration. For example, the cloud service 1601 may include various servers, such as a server that saves and manages moving images, a server that delivers moving images to terminals, a server that acquires moving images from terminals, and a server that manages users (terminals) and payments, as well as any type of network, such as the Internet or a LAN.

The computer 1611 includes an information processing apparatus such as a personal computer, server, or workstation, for example. The AV equipment 1612 includes image processing apparatus such as a television receiver, a hard disk recorder, a game console, or a camera, for example. The mobile information processing terminal 1613 includes a mobile information processing apparatus such as a notebook personal computer, a tablet terminal, a mobile telephone, or a smartphone, for example. The IoT device 1614 includes any object that executes image-related processing, such as a machine, an electric appliance, a piece of furniture, some other thing, an IC tag, or a card-shaped device, for example. These terminals all include a communication function, and are able to connect to (establish a session with) the cloud service 1601 and exchange information with (that is, communicate with) the cloud service 1601. Also, each terminal is also able to communicate with another terminal. Communication between terminals may be performed by going through the cloud service 1601, or may be performed without going through the cloud service 1601.

When the present technology is applied to the network system 1600 as above, and image (moving image) data is exchanged between terminals or between a terminal and the cloud service 1601, the image data may be encoded/decoded as described above in each of the embodiments. In other words, the terminals (from the computer 1611 to the IoT device 1614) and the cloud service 1601 each may include the functions of the image encoding apparatus 10 and the image decoding apparatus 60 described above. With this arrangement, it is possible to further decrease the amount of transmission related to parameters.

### <8. Conclusion>

According to an embodiment of the present disclosure as described above, it is possible to decrease the amount of transmission related to parameters further.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Control information related to the present technology described in each of the above embodiments may be transmitted from the encoding side to the decoding side. For example, control information that controls whether or not to allow (or deny) the application of the present technology described above may be transmitted. Also, for example, control information that specifies an upper limit, a lower limit, or both of a block size that allows (or denies) the application of the present technology described above may be transmitted.

Note that the terms CU, PU, and TU stated in this specification refer to the logical units, including syntax, that are associated with individual blocks in HEVC. In the case of focusing on only individual blocks as a portion of an image, these terms may be substituted with the terms coding block (CB), prediction block (PB), and transform block (TB), respectively. CBs are formed by recursively dividing a coding tree block (CTB) into a quadtree structure. One entire quadtree corresponds to a CTB, and the logical unit corresponding to a CTB is called a coding tree unit (CTU). The CTB and CB in HEVC play a role similar to macroblocks in H.264/AVC by being the units of processing in the encoding process. However, the CTB and CB are different from macroblocks in that their sizes are not fixed (the size of a macroblock is always 16×16 pixels). The size of the CTB is selected from 16×16 pixels, 32×32 pixels, and 64×64 pixels, and is designated by a parameter in the encoded stream. The size of the CB may change depending on the depth of the division of the CTB.

Also, although the above describes an example in which (inverse) quantization using a quantization parameter specified on the basis of feature quantities is performed in the quantization control process, the present technology is not limited to such an example. For example, the image encoding apparatus may also specify and transmit to the image decoding apparatus a differential quantization parameter dQP for further adjusting the quantization parameter specified on the basis of feature quantities. Note that in such a case, the differential quantization parameter dQP does not have to be transmitted for each and every CU, and may be transmitted only for some CUs.

Also, in the above encoding process, when searching for a quantization parameter on the basis of the feature quantity A3 or the feature quantity A4, a provisional quantization parameter q whose value matches the quantization parameter QP′ corresponding to the provisional quantization parameter q may not exist in some cases.

In such a case, the image encoding apparatus 10 may change the conditions and search for a quantization parameter again. For example, the image encoding apparatus 10 may perform an operation on the values of the transform coefficients (for example, perform a coefficient cut such that the highest-order coefficient or the number of non-zero coefficients is different) and search for a quantization parameter again. Also, the image encoding apparatus 10 may change the prediction mode, use the transform coefficients of the prediction error data based on a different prediction mode, and search for a quantization parameter again. Also, the image encoding apparatus 10 may change the threshold value TH_A3 or TH_A4 related to the feature quantity A3 or the feature quantity A4, and search for a quantization parameter again.

Also, control parameters for turning off the (inverse) quantization control function based on the feature quantity A3 or the feature quantity A4 may be transmitted from the image encoding apparatus to the image decoding apparatus. In such a case, the control parameters may be transmitted in units of sequences, units of pictures, or units of blocks.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1)

An image processing apparatus including:

an inverse quantization control section that controls an inverse quantization on the basis of prediction block information or quantized coefficients.
(2)

The image processing apparatus according to (1), further including:

a feature quantity detection section that acquires a feature quantity on the basis of prediction block information or quantized coefficients, in which

the inverse quantization control section controls the inverse quantization on the basis of the feature quantity.
(3)

The image processing apparatus according to (2), in which

the feature quantity detection section acquires the feature quantity on the basis of a predicted image generated on the basis of the prediction block information.
(4)

The image processing apparatus according to (3), in which

the feature quantity detection section acquires a feature quantity indicating a dynamic range in the predicted image.
(5)

The image processing apparatus according to (3) or (4), in which

the feature quantity detection section acquires a feature quantity indicating a variance in the predicted image.
(6)

The image processing apparatus according to any one of (2) to (5), in which

the feature quantity detection section acquires a feature quantity indicating a position of a highest-order coefficient in the quantized coefficients.
(7)

The image processing apparatus according to any one of (2) to (6), in which

the feature quantity detection section acquires a feature quantity indicating a coefficient distribution density in the quantized coefficients.
(8)

The image processing apparatus according to any one of (2) to (7), in which

the feature quantity detection section acquires a feature quantity indicating a prediction mode included in the prediction block information.
(9)

The image processing apparatus according to any one of (2) to (8), in which

the inverse quantization control section controls the inverse quantization by specifying a quantization parameter used to inversely quantize an encoded block on the basis of the feature quantity.
(10)

The image processing apparatus according to (4) or (5), in which

the inverse quantization control section controls the inverse quantization by specifying a quantization parameter used to inversely quantize a direct-current component in an encoded block on the basis of the feature quantity.

The image processing apparatus according to (6) or (7), in which

the inverse quantization control section controls the inverse quantization by specifying a quantization parameter used to inversely quantize a predetermined frequency component in an encoded block on the basis of the feature quantity.
(12)

An image processing method including, by a processor: controlling an inverse quantization on the basis of prediction block information or quantized coefficients.
(13)

A program causing a computer to execute a function of:

controlling an inverse quantization on the basis of prediction block information or quantized coefficients.

### REFERENCE SIGNS LIST

10 image encoding apparatus
11 buffer
12 control section
13 subtraction section
14 orthogonal transform section
15 quantization section
16 lossless encoding section
17 accumulation buffer
21 inverse quantization section
22 inverse orthogonal transform section
23 addition section
24 deblocking filter
25 filter
26 frame memory
27 switch
28 mode setting section
30 intra-prediction section
40 inter-prediction section
60 image decoding apparatus
61 accumulation buffer
62 lossless decoding section
63 inverse quantization section
64 inverse orthogonal transform section
65 addition section
66 deblocking filter
67 filter
68 buffer
69 D/A conversion section
70 frame memory
80 intra-prediction section
90 inter-prediction section
151 feature quantity detection section
152 quantization control section
153 quantization operation section
631 feature quantity detection section
632 inverse quantization control section
633 inverse quantization operation section

1. An image processing apparatus comprising:
an inverse quantization control section that controls an inverse quantization on a basis of prediction block information or quantized coefficients.

2. The image processing apparatus according to claim 1, further comprising:
a feature quantity detection section that acquires a feature quantity on a basis of prediction block information or quantized coefficients, wherein
the inverse quantization control section controls the inverse quantization on a basis of the feature quantity.

3. The image processing apparatus according to claim 2, wherein
the feature quantity detection section acquires the feature quantity on a basis of a predicted image generated on a basis of the prediction block information.

4. The image processing apparatus according to claim 3, wherein
the feature quantity detection section acquires a feature quantity indicating a dynamic range in the predicted image.

5. The image processing apparatus according to claim 3, wherein
the feature quantity detection section acquires a feature quantity indicating a variance in the predicted image.

6. The image processing apparatus according to claim 2, wherein
the feature quantity detection section acquires a feature quantity indicating a position of a highest-order coefficient in the quantized coefficients.

7. The image processing apparatus according to claim 2, wherein
the feature quantity detection section acquires a feature quantity indicating a coefficient distribution density in the quantized coefficients.

8. The image processing apparatus according to claim 2, wherein
the feature quantity detection section acquires a feature quantity indicating a prediction mode included in the prediction block information.

9. The image processing apparatus according to claim 2, wherein
the inverse quantization control section controls the inverse quantization by specifying a quantization parameter used to inversely quantize an encoded block on a basis of the feature quantity.

10. The image processing apparatus according to claim 4, wherein
the inverse quantization control section controls the inverse quantization by specifying a quantization parameter used to inversely quantize a direct-current component in an encoded block on a basis of the feature quantity.

11. The image processing apparatus according to claim 6, wherein
the inverse quantization control section controls the inverse quantization by specifying a quantization parameter used to inversely quantize a predetermined frequency component in an encoded block on a basis of the feature quantity.

12. An image processing method comprising, by a processor:
controlling an inverse quantization on a basis of prediction block information or quantized coefficients.

13. A program causing a computer to execute a function of:
controlling an inverse quantization on a basis of prediction block information or quantized coefficients.
